(19) United States
(12) Patent Application Publication
(10) Pub. No.: US 2019/0385322 A1
(43) Pub. Date: Dec. 19, 2019

(54) THREE-DIMENSIONAL SHAPE IDENTIFICATION METHOD, AERIAL VEHICLE, PROGRAM AND RECORDING MEDIUM

(71) Applicant: SZ DJI TECHNOLOGY CO., LTD., Shenzhen (CN)

(72) Inventors: Lei GU, Tokyo (JP); Bin CHEN, Tokyo (JP)

(21) Appl. No.: 16/557,667

(22) Filed: Aug. 30, 2019

Related U.S. Application Data
(63) Continuation of application No. PCT/JP2017/008385, filed on Mar. 2, 2017.

(51) Int. Cl. G06T 7/55; G06T 7/60; B64C 39/02

(52) U.S. Cl. CPC G06T 7/55; G06T 7/60; B64C 39/024; G06T 2207/10032; B64C 2201/141; B64C 2201/146; B64C 2201/027; B64C 2201/123; G06T 2207/10012

(57) ABSTRACT

A three-dimensional shape estimation method includes acquiring object information of a target object captured by an aerial vehicle while flying at a plurality of flight heights and estimating a three-dimensional shape of the target object based on the object information.

### CROSS-REFERENCE TO RELATED APPLICATION

This application is a continuation of International Application No. PCT/JP2017/008385, filed on Mar. 2, 2017, the entire content of which is incorporated herein by reference.

### TECHNICAL FIELD

The present disclosure relates to a three-dimensional shape estimation method of an object photographed by an aerial vehicle. The present disclosure further relates to an aerial vehicle, a program, and a recording medium.

### BACKGROUND

In conventional technology, a platform such as an Unmanned Aerial Vehicle (UAV) may be equipped with an imaging device to capture images while flying along a predetermined fixed path. The platform may receive commands such as flight routes and image capturing instructions from a ground station, execute the flight based on the commands, capture images, and transmit the captured images to the ground station. When capturing images of an object, the platform may move along the predetermined fixed path while tilting the imaging device of the platform based on a positional relationship between the platform and the imaging object.

Further, in conventional technology, the three-dimensional shape of an object such as a building may be estimated based on a plurality of captured images, such as the aerial images captured by a UAV flying in the air. In order to automate the imaging process of a UAV (e.g., aerial photography), a technique of pre-generating a flight route of a UAV may be used. As such, in order to estimate the three-dimensional shape of an object such as a building using a UAV, it may be necessary to fly the UAV along a pre-generated flight route and capture a plurality of images of the object acquired by the UAV at different imaging positions in the flight route.

### REFERENCE

Patent document: Japanese Application Publication JP 2010-061216.

### SUMMARY

If the shape of the object such as a building being estimated by the UAV is relatively simple (e.g., a cylindrical shape), the change in shape may not occur due to the height of the object. As such, the UAV may fly in a circular direction from a fixed flight center at a fixed flight radius and change the flight height while imaging the object. Therefore, it may be possible to ensure the distance from the UAV to the object is not affected by the height of the object and capture the object satisfying the desired resolution set in the UAV, thereby estimating the three-dimensional shape of the object based on the capture images acquired from imaging.

However, if the shape of the object such as a building is a complex shape that varies with height (e.g., an oblique cylinder or a cone), the center of the object in the height direction may not be fixed. As such, the flight radius of the UAV may not be fixed. Therefore, in the patent document listed in the Reference above, the resolution of the captured image acquired by the UAV may be deviated due to the height of the object, and it may be difficult to estimate the three-dimensional shape of the object based on the captured image acquired from imaging. Further, since the shape of the object may change based on the height, and it may not be easy to generate a flight route of the UAV in advance. As such, the UAV may collide with the object such as a building during flight.

In accordance with the disclosure, there is provided a three-dimensional shape estimation method including acquiring object information of a target object captured by an aerial vehicle while flying at a plurality of flight heights and estimating a three-dimensional shape of the target object based on the object information.

Also in accordance with the disclosure, there is provided an aerial vehicle including a memory storing a program and a processor coupled to the memory and configured to execute the program to acquire object information of a target object captured by the aerial vehicle while flying at a plurality of flight heights and estimate a three-dimensional shape of the target object based on the object information.

Also in accordance with the disclosure, there is provided a computer-readable recording medium storing a computer program that, when executed by a processor of an aerial vehicle, causes the processor to acquire object information of a target object captured by the aerial vehicle while flying at a plurality of flight heights and estimate a three-dimensional shape of the target object based on the object information.

### BRIEF DESCRIPTION OF THE DRAWINGS

FIG. 1 is a diagram illustrating an example first configuration of a three-dimensional shape estimation system according to an embodiment of the present disclosure.

FIG. 2 is a diagram illustrating an example of the appearance of a UAV.

FIG. 3 is a diagram illustrating an example of a specific appearance of the UAV.

FIG. 4 is a block diagram illustrating an example hardware configuration of the UAV included in the three-dimensional shape estimation system of FIG. 1.

FIG. 5 is a diagram illustrating an example of the appearance of a transmitter.

FIG. 6 a block diagram illustrating an example hardware configuration of the transmitter included in the three-dimensional shape estimation system of FIG. 1.

FIG. 7 is a diagram illustrating an example second configuration of the three-dimensional estimation system according to an embodiment of the present disclosure.

FIG. 8 is a block diagram illustrating an example hardware configuration of the transmitter included in the three-dimensional shape estimation system of FIG. 7.

FIG. 9 is a block diagram illustrating an example hardware configuration of the UAV included in the three-dimensional shape estimation system of FIG. 7.

FIG. 10 is a diagram illustrating an example third configuration of the three-dimensional shape estimation system according to an embodiment of the present disclosure.

FIG. 11 is a perspective view illustrating an example of the appearance of the transmitter in which a communication terminal (e.g., a tablet terminal) is mounted, which is included in the three-dimensional shape estimation system of FIG. 10.

FIG. 12 is a perspective view illustrating an example of the appearance of the transmitter in which the communication terminal (e.g., a smartphone) is mounted, which is included in the three-dimensional shape estimation system of FIG. 10.

FIG. 13 is a block diagram illustrating an example of an electrical connection relationship between the transmitter and the communication terminal included in the three-dimensional shape estimation system of FIG. 10.

FIG. 14A is a plan view of the periphery of an object viewed from above.

FIG. 14B is a front view of the object viewed from the front.

FIG. 15 is an explanatory diagram for calculating of a horizontal imaging interval.

FIG. 16 is a view illustrating an example of a horizontal angle.

FIG. 17 is an explanatory diagram illustrating an outline of an operation of estimating a three-dimensional shape of an object according to an embodiment of the present disclosure.

FIG. 18 is a flowchart illustrating an example of an operation procedure of a three-dimensional shape estimation method according to an embodiment of the present disclosure.

FIG. 19A is a flowchart illustrating an example of the operation procedure of a modification of S7 of FIG. 18.

FIG. 19B is a flowchart illustrating an example of the operation procedure of another modification of S7 of FIG. 18.

FIG. 20 is an explanatory diagram illustrating the outline of the operation of estimating the three-dimensional shape of the object according to another embodiment of the present disclosure.

FIG. 21 is a flowchart illustrating an example of the operation procedure of the three-dimensional shape estimation method according to another embodiment of the present disclosure.

### DETAILED DESCRIPTION OF THE EMBODIMENTS

The technical solutions provided in the embodiments of the present disclosure will be described below with reference to the drawings. However, it should be understood that the following embodiments do not limit the disclosure. It will be appreciated that the described embodiments are some rather than all of the embodiments of the present disclosure. Other embodiments conceived by those having ordinary skills in the art on the basis of the described embodiments without inventive efforts should fall within the scope of the present disclosure. In the situation where the technical solutions described in the embodiments are not conflicting, they can be combined. It should be noted that technical solutions provided in the present disclosure do not require all combinations of the features described in the embodiments of the present disclosure.

The three-dimensional shape estimation system of the present disclosure may include an unmanned aerial vehicle (UAV) as an example of a moving body and a mobile platform for remotely controlling the action or processing of the UAV.

A UAV may include an aircraft that moves in the air (e.g., a drone or a helicopter). The UAV may fly in a horizontal and circumferential direction within a flight range (also referred to as a flight route) of each flight height set based on the height of the object (also referred to as a “target object,” e.g., a building with an irregular shape). The flight range of each flight height may be set to surround the periphery of the object, for example, the flight range may be set to a circle. The UAV may perform aerial photography of the object during the flight within the flight range of each flight height.

In addition, in the following description, in order to better describe the features of the three-dimensional shape estimation system of the present disclosure, an object with a relatively complex shape is described, such as an oblique cylinder or a cone. Further, the shape of the object may change based on the flight height of the UAV. However, the shape of the object may also be a relatively simple shape such as a cylindrical shape. That is, the shape of the object may not vary based on the flight height of the UAV.

The mobile platform may be a computer, for example, a transmitter for the remote control of various processes including the movement of the UAV, or a communication terminal that may be connected to the transmitter such that data and information may be input or output. In addition, the UAV itself may be included as the mobile platform.

The three-dimensional shape estimation method of the present disclosure may define various processes or steps in the three-dimensional shape estimation system, the UAV, or the mobile platform.

The recording medium of the present disclosure may be recorded with a program (i.e., a program for causing the UAV or the mobile platform to perform the various processes or steps).

The program of the present disclosure may be a program for causing the UAV or the mobile platform to perform the various processes or steps.

In one embodiment, the UAV 100 may set an initial flight range (refer to an initial flight route C1 shown in FIG. 17) for flying around the object based on a plurality of input parameters (refer to the following description).

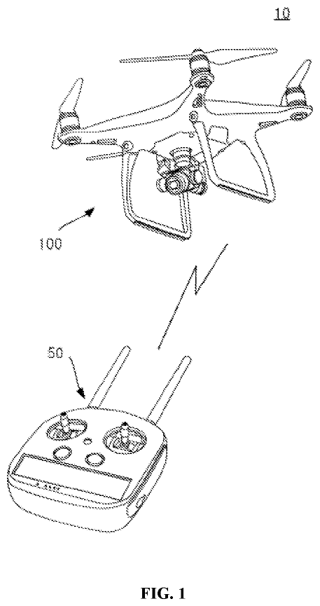

FIG. 1 is a diagram illustrating an example first configuration of a three-dimensional shape estimation system 10 according to an embodiment of the present disclosure. As shown in FIG. 1, the three-dimensional shape estimation system 10 includes at least a UAV 100 and a transmitter 50. The UAV 100 and the transmitter 50 may mutually communication information and data by wired communication or wireless communication (e.g., a wireless Local Area Network (LAN) or Bluetooth). In addition, the illustration of the case where a communication terminal 80 may be mounted on the housing of the transmitter 50 is omitted in FIG. 1. The transmitter 50 as an example of an operation terminal may be used in a state where the person using the transmitter 50 (hereinafter referred to as “user”) may be holding the transmitter with both hands.

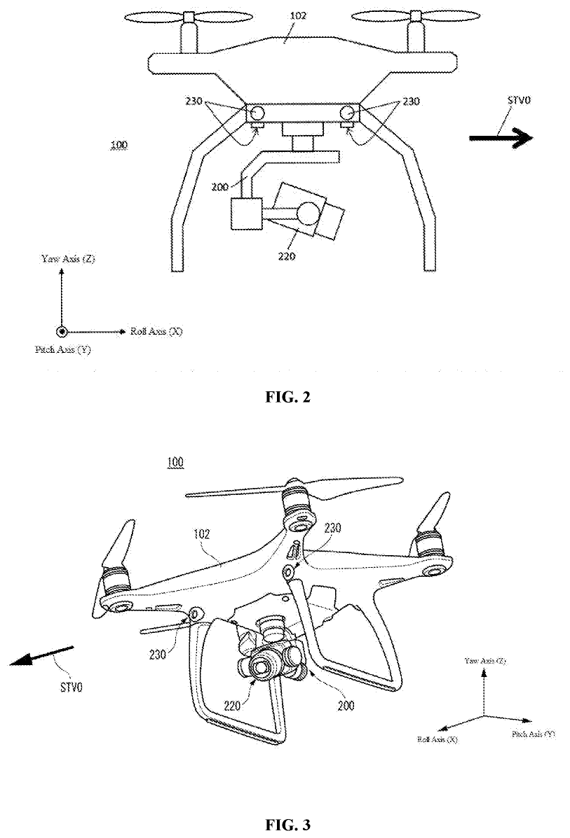

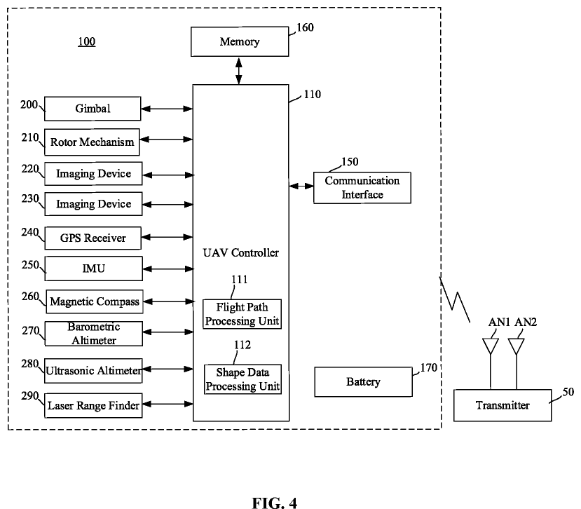

FIG. 2 is a diagram illustrating an example of the appearance of the UAV 100 and FIG. 3 is a diagram illustrating an example of a specific appearance of the UAV 100. For example, FIG. 2 may be a side view illustrating the UAV 100 flying in the moving direction STV0, and FIG. 3 may be a perspective view illustrating the UAV 100 flying in the moving direction STV0. The UAV 100 may be an example of a moving body that includes imaging devices 220 and 235 as an example of the imaging unit that moves. The moving body may include other aircrafts moving in the air, a vehicle moving on the ground, a ship moving on the water, etc. in addition to the UAV 100.

As shown in FIG. 2 and FIG. 3, the roll axis (e.g., the x-axis) may be defined as a direction parallel to the ground and along the moving direction STV0. The pitch axis (e.g., the y-axis) may be determined to be a direction parallel to the ground and perpendicular to the roll axis. Further, the yaw axis (e.g., the z-axis) may be determined to be a direction perpendicular to the ground and perpendicular to the roll axis and the pitch axis.

As shown in FIG. 3, the UAV 100 includes a UAV body 102, a gimbal 200, an imaging device 220, and a plurality of imaging devices 230. The UAV 100 may move based on a remote control instruction transmitted from the transmitter 50, which may be an example of the mobile platform related to the present disclosure. The movement of the UAV 100 may refer to a flight, including at least an ascending, a descending, a left turn, a right turn, a left horizontal move, and a right horizontal move flight.

The UAV body 102 may include a plurality of rotors, and the UAV body 102 may facilitate the UAV 100 to move by controlling the rotation of the plurality of rotors. In some embodiments, the UAV body 102 may facilitate the UAV 100 to move by using, for example, 4 rotors, however, the number of the rotors is not limited to 4. In addition, the UAV 100 may also be a fixed-wing aircraft with the rotors.

The imaging device 220 may be a photographing camera that may be used to photograph an object (e.g., a building having an irregular shape mentioned above) included in a desired imaging range. In addition, the object may include a scene above the object of the aerial image of the UAV 100, scenery of mountains, rivers, etc.

The plurality of imaging device 230 may be sensing cameras for capturing the surrounding images of the UAV 100 for controlling the movement of the UAV 100. In some embodiments, two imaging devices 230 may be disposed at the nose (i.e., the front side) of the UAV 100, and/or two imaging devices 230 may be disposed on the bottom surface of the UAV 100. The two imaging devices 230 on the front side may be paired to function as a so-called stereo camera. The two imaging devices 230 on the bottom surface side may be paired to function as a stereo camera. As such, the three-dimensional spatial data around the UAV 100 may be generated based on the images captured by the plurality of image devices 230. In addition, the number of imaging devices 230 included in the UAV 100 may not be limited to 4. For example, the UAV 100 may include at least one imaging device 230. In another example, the UAV 100 may include at least one imaging device 230 at the nose, at least one imaging device 230 at the tail, at least one imaging device 230 at each side surface, at least one imaging device 230 at the bottom surface, and at least one imaging device 230 at the top surface of the UAV 100, respectively. The viewing angle that may be set in the imaging devices 230 may be larger than the viewing angle that may be set in the imaging device 220. In some embodiments, the imaging devices 230 may include a single focus lens or a fisheye lens.

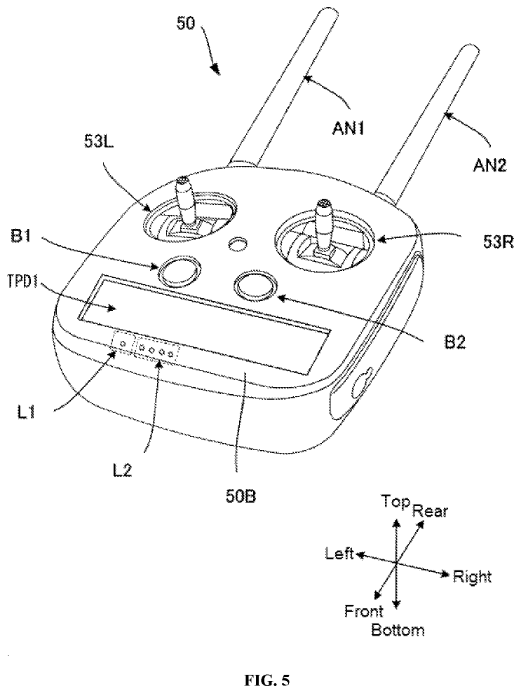

FIG. 4 is a block diagram illustrating an example hardware configuration of the UAV included in the three-dimensional shape estimation system of FIG. 1. The UAV 100 may be configured to include a UAV controller 110, a communication interface 150, a memory 160, a battery 170, a gimbal 200, a rotor mechanism 210, an imaging device 220, an imaging device 230, a GPS receiver 240, an Inertial Measurement Unit (IMU) 250, a magnetic compass 260, a barometric altimeter 270, an ultrasonic altimeter 280, and a laser range finder 290.

The UAV controller 110 may include, for example, a Central Processing Unit (CPU), a Micro Processing Unit (MPU), or a Digital Signal Processor (DSP). The UAV controller 110 may be configured to perform the signal processing for the overall controlling of the actions of the respective parts of the UAV 100, the input/output processing of data between the various respective parts, the arithmetic processing of the data, and the storage processing of the data.

The UAV controller 110 may be used to control the flight of the UAV 100 based on a program stored in the memory 160. The UAV controller 110 may be used to control the movement (i.e., flight) of the UAV 100 based on an instruction received from the remote transmitter 50 through the communication interface 150. In some embodiments, the memory 160 may be detached from the UAV 100.

The UAV controller 110 may specify the environment around the UAV 100 by analyzing a plurality of images captured by the plurality of images devices 230. In some embodiments, the UAV controller 110 may control the flight, such as avoiding an obstacle, based on the environment around the UAV 100. Further, the UAV controller 110 may generate the three-dimensional spatial data around the UAV 100 based on the plurality of images captured by the plurality of imaging devices 230 and control the flight based on the three-dimensional spatial data.

The UAV controller 110 may be configured to acquire date and time information indicating the current date and time. In some embodiments, the UAV controller 110 may be configured to acquire the date and time information indicating the current date and time from the GPS receiver 240. In addition, the UAV controller 110 may be configured to acquire the data and time information indicating the current date and time from a timer (not shown) mounted on the UAV 100.

The UAV controller 110 may be configured to acquire position information indicating the position of the UAV 100. In some embodiments, the UAV controller 110 may be configured to acquire the position information indicating the latitude, longitude, and altitude at which the UAV 100 may be located from the GPS receiver 240. More specifically, the UAV controller 110 may be configured to acquire the latitude and longitude information indicating the latitude and longitude of the UAV 100 from the GPS receiver 240, and acquire the height information indicating the height of the UAV 100 from the barometric altimeter 270 or the ultrasonic altimeter 280, respectively as the position information.

The UAV controller 110 may be configured to acquire orientation information indicating the orientation of the UAV 110 from the magnetic compass 260. The orientation information may indicate, for example, an orientation corresponding to the orientation of the nose of the UAV 100.

The UAV controller 110 may be configured to acquire the position information indicating a position where the UAV 110 should be at when the imaging device 220 captures an imaging range that is to be captured. In some embodiments, the UAV controller 110 may be configured to acquire the position information indicating the position where the UAV should be at from the memory 160. In addition, the UAV controller 110 may be configured to acquire the position information indicating the position where the UAV 100 should be at from the other devices such as the transmitter 50 via the communication interface 150. In order to capture the imaging range that needs to be captured, the UAV controller 110 may specify the position where the UAV 100 should be at with reference to a three-dimensional map database, and acquire the position as the position information indicating the position where the UAV 100 should be at.

The UAV controller 110 may be configured to acquire imaging information indicating an imaging range of each of the imaging device 220 and the imaging device 230. The UAV controller 110 may be configured to acquire viewing angle information indicating the viewing angles of the imaging device 220 and the imaging device 230 from the imaging device 220 and the imaging device 230 as the parameters for specifying the imaging range. In some embodiments, the UAV controller 110 may be configured to acquire information indicating the photographing directions of the imaging device 220 and the imaging device 230 as the parameters for specifying the imaging range. The UAV controller 110 may be configured to acquire attitude information indicating the attitude state of the imaging device 220 from the gimbal 200, such as the information indicating the photographing direction of the imaging device 220. The UAV controller 110 may be configured to acquire information indicating the orientation of the UAV 100. The information indicating the attitude state of the imaging device 220 may indicate the angle at which the gimbal 200 may be rotated from the reference rotation angles of the pitch axis and the yaw axis. The UAV controller 110 may be configured to acquire the position information indicating the position of the UAV 100 as a parameter for specifying the imaging range. In some embodiments, the UAV controller 110 may be configured to acquire the imaging information by specifying the imaging range indicating the geographical range captured by the imaging device 220 and generating the imaging information indicating the imaging range based on the viewing angle and the photographing direction of the imaging device 220 and the imaging device 230, and the position of the UAV 100.

The UAV controller 110 may be configured to acquire imaging information indicating the imaging range that the imaging device 220 should capture. The UAV controller 110 may be configured to acquire the imaging information that the imaging device 220 should capture from the memory 160. Alternatively, the UAV controller 110 may be configured to acquire the imaging information that the imaging device 220 should capture from the other devices such as the transmitter 50 via the communication interface 150.

The UAV controller 110 may be configured to acquire stereoscopic information indicating a three-dimensional shape of an object in the surroundings of the UAV 100. The object may be a part of a landscape such as a building, a road, a vehicle, or a tree. The stereoscopic information may be, for example, three-dimensional spatial data. The UAV controller 110 may be configured to generate the stereoscopic information indicating a three-dimensional shape of an object in the surroundings of the UAV 100 based on each image obtained by the plurality of imaging devices 230, thereby acquiring the stereoscopic information. In some embodiments, the UAV controller 110 may be configured to acquire the stereoscopic information indicating a three-dimensional shape of an object in the surroundings of the UAV 100 by referring to a three-dimensional map database stored in the memory 160. In some embodiments, the UAV controller 110 may be configured to acquire the stereoscopic information indicating a three-dimensional shape of an object in the surroundings of the UAV 100 by referring to a three-dimensional map database managed by a server in a network.

The UAV controller 110 may be configured to acquire imaging data (hereinafter sometimes referred to as “captured image”) acquired by the imaging device 220 and the imaging device 230.

The UAV controller 110 may be used to control the gimbal 200, the rotor mechanism 210, the imaging device 220, and the imaging device 230. The UAV controller 110 may be used to control the imaging range of the imaging device 220 by changing the photographing direction or the viewing angle of the imaging device 220. In some embodiments, the UAV controller 110 may be used to control the imaging range of the imaging device 220 supported by the gimbal 220 by controlling the rotation mechanical of the gimbal 200.

In the present disclosure, the imaging range may refer to a geographical range that can be captured by the imaging device 220 or the imaging device 230. The imaging range may be defined by latitude, longitude, and altitude. In some embodiments, the imaging range may be a range of three-dimensional spatial data defined by latitude, longitude, and altitude. In some embodiments, the imaging range may be specified based on the viewing angle and the photographing direction of the imaging device 220 or the imaging device 230, and the position of the UAV 110. The photographing direction of the imaging device 220 and the imaging device 230 may be defined by the orientation and the depression angle of the imaging device 220 and the imaging device 230 including an imaging lens disposed on the front surface. In some embodiments, the photographing direction of the imaging device 220 may be a direction specified by the nose direction of the UAV 100 and the attitude data of the imaging device 220 of the gimbal 200. In some embodiments, the photographing direction of the imaging device 230 may be a direction specified by the nose direction of the UAV 100 and the position where the imaging device 230 may be provided.

The UAV controller 110 may be used to control the flight of the UAV 100 by controlling the rotor mechanism 210. For example, the UAV controller 100 may be used to control the position including the latitude, longitude, and altitude of the UAV 100 by controlling the rotor mechanism 210. The UAV controller 110 may be used to control the imaging ranges of the imaging device 220 and the imaging device 230 by controlling the flight of the UAV 100. In addition, the UAV controller 110 may be used to control the viewing angle of the imaging device 220 by controlling the zoom lens included in the imaging device 220. In some embodiments, the UAV controller 210 may be used to control the viewing angle of the imaging device 220 through digital zooming by using the digital zooming function of the imaging device 220. The UAV controller 110 may cause the imaging device 220 or the imaging device 230 to capture images of the object in the horizontal direction, a predetermined angle direction, or the vertical direction at an imaging position (e.g., a waypoint, which will be described later) included in the flight range (flight path) set for each flight height. The predetermined angle direction may be a direction with a predetermined angular value suitable for the UAV 100 or the mobile platform to perform the three-dimensional shape estimation of the object.

When the imaging device 220 is fixed to the UAV 100 and the imaging device 220 is not moving, the UAV controller 110 may cause the imaging device 220 to capture a desired imaging range in a desired environment by moving the UAV 100 to a specific position on a specific date. Alternatively, when the imaging device 220 does not include the zoom function and the viewing angle of the imaging device 220 cannot be changed, the UAV controller 110 may cause the imaging device 220 to capture a desired imaging range in a desired environment by moving the UAV 100 to a specific position on a specific date.

In addition, the UAV controller 110 further includes a flight path processing unit 111 and a shape data processing unit 112. The flight path processing unit 111 may be configured to perform a processing related to the generation of the flight range set for each flight height of the UAV 100. The shape data processing unit 112 may be configured to perform a processing related to the generation and estimation of the three-dimensional shape data of the object.

As an example of an acquisition unit, the flight path processing unit 111 may be configured to acquire a plurality of input parameters. Alternatively, the flight path processing unit 111 may acquire the input parameters by receiving the input parameters from the transmitter 50 through the communication interface 150. The acquired input parameters may be stored in the memory 160. The input parameters may include, for example, height information Hₛₜₐᵣₜ of the initial flight range (i.e., the initial flight range or the initial flight path C1 in FIG. 17) of the UAV 100 flying around the object or information on a center position PO (e.g. latitude and longitude) of the initial flight path C1. In addition, the input parameters may include initial flight radius R_{flight0} information indicating the radius of the initial flight path of the UAV 100 flying along the initial flight path C1, or radius R_{obj0} information of the object and information on the set resolution. Further, the set resolution may indicate the resolution of the captured imaged acquired by the imaging devices 220 and 230 (i.e., a suitable captured image may be acquired to ensure that the resolution of the three-dimensional shape of an object BL may be estimated with high precision), and the captured image may be stored in the memory 160 of the UAV 100.

In one embodiment, in addition to the parameters mentioned above, the input parameters may further include imaging position (e.g., waypoint) information in the initial flight path C1 of the UAV 100, and various parameters for generating a flight path through the imaging position, where the imaging position may be a position in the three-dimensional space.

In one embodiment, the input parameters may include, for example, an imaging position (e.g., waypoint) set within a flight range (e.g., initial flight path C1, flight paths C2, C3, C4, C5, C6, C7, and C8) of each flight height shown in FIG. 17, and repetition rate information of the imaging range when the UAV 100 captures the object BL. Further, the input parameters may include at least one of end height information indicating the final flight height of the UAV 100 to estimate the three-dimensional shape of the object BL, and initial imaging position information of the flight path. Furthermore, the input parameters may include imaging position interval information within a flight range (e.g., initial flight path C1, flight paths C2 to C8) of each flight height.

In one embodiment, the flight path processing unit 111 may be configured to acquire at least a part of information included in the input parameters from devices other than the transmitter 50. For example, the flight path processing unit 111 may receive and acquire identification information of the specific object through the transmitter 50. Further, the flight path processing unit 111 may communicate with an external server via the communication interface 150 based on the identification information of the specific object, and receive and acquire radius information of the object corresponding to the object identification information and height information of the object.

The repetition rate of the imaging range may indicate a repetition ratio of the two imaging ranges of adjacent imaging positions in the horizontal direction or the vertical direction when the imaging device 220 or the imaging device 230 performs imaging. The repetition rate of the imaging range may include at least one of repetition rate information of the imaging range in the horizontal direction (also referred to as the horizontal repetition rate) and repetition rate information of the imaging range in the vertical direction (also referred to as the vertical repetition rate). The horizontal repetition rate and the vertical repetition rate may be the same or different. When the horizontal repetition rate and the vertical repetition rate are different, the horizontal repetition rate information and the vertical repetition rate information may be included in the input parameters. When the horizontal repetition rate and the vertical repetition rate are the same, a piece of repetition rate information of the same value may be included in the input parameters.

The imaging position interval may be a spatial imaging interval, which may be a distance between adjacent imaging positions among a plurality of imaging positions at which the UAV 100 should capture the image in the flight path. The imaging position interval may include at least one of an imaging position interval in the horizontal direction (also referred to as the horizontal imaging interval) and an imaging position interval in the vertical direction (also referred to as the vertical imaging interval). The flight path processing unit 111 may calculate and acquire the imaging position interval including the horizontal imaging interval and the vertical imaging interval, or the flight path processing unit 111 may acquire the imaging position interval from the input parameters.

That is, the flight path processing unit 111 may arrange the imaging position (e.g., waypoint) captured by the imaging device 220 or 230 within the flight range (e.g., flight path) of each flight height. The intervals of the imaging positions (i.e., imaging position intervals) may be arranged, for example, at equal intervals. The imaging position may be arranged such that the relevant imaging ranges of the captured image at the adjacent imaging position may be partially repeated. As such, a plurality of captured images may be used to estimate the three-dimensional shape. Further, since the imaging device 220 or 230 has a predetermined angle of view, therefore, by shortening the imaging position interval, a part of the two imaging ranges may be repeated.

The flight path processing unit 111 may calculate the imaging position interval based on, for example, an arrangement height (e.g., an imaging height) of the imaging position and the resolution of the imaging device 220 or 230. The higher the imaging height or the longer the imaging distance, the greater the repetition rate of the imaging range. Therefore, the imaging position interval may be extended (lessened). Further, the lower the imaging height or the shorter the imaging distance, the lower the repetition rate of the imaging range. Therefore, the imaging position interval may be shortened (intensified). In one embodiment, the flight path processing unit 111 may calculate the imaging position interval based on the angle of view of the imaging device 220 or 230. In another embodiment, the flight path processing unit 111 may calculate the imaging position interval by other well-known methods.

The flight range (e.g., flight route) may be a range including a flight path in which the UAV 100 may be flying in a horizontal (in other words, substantially no change in flight height) and circumferential direction around the object as a peripheral end portion. Further, the flight range (e.g., flight route) may be a range in which the cross-sectional shape of the flight range may be approximately circular when viewed from directly above. The cross-sectional shape of the flight range may be of a shape other than a circle (e.g., a polygon) when viewed from directly above. Furthermore, the flight path (e.g., flight route) may include a plurality of flight routes having different heights (e.g., imaging heights). The flight path processing unit 111 may calculate the flight range based on the center position information (e.g., latitude and longitude information) of the object and the radius information of the object. The flight path processing unit 111 may approximate the object to a circle based on the center position of the object and the radius of the object, and calculate the flight range. In addition, the flight path processing unit 111 may acquire the flight range information generated by the transmitter 50 included in the input parameters.

The flight path processing unit 111 may be configured to acquire viewing angle information of the imaging device 220 or the imaging device 230 from the imaging device 220 or the imaging device 230. The angle of view of the imaging device 220 or the angle of view of the imaging device 230 in the horizontal direction and the vertical direction may be the same or different. The angle of view of the imaging device 220 or 230 in the horizontal direction may be referred to as a horizontal viewing angle. Further, the angle of view of the imaging device 220 or 230 in the vertical direction may be referred to as a vertical viewing angle. When the horizontal viewing angle and vertical viewing angle are the same, the flight path processing unit 111 may acquire a piece of viewing angle information of the same value.

In one embodiment, the flight path processing unit 111 may be configured to calculate the horizontal imaging interval based on the radius of the object, the horizontal viewing angle of the imaging device 220 or 230, and the horizontal repetition rate of the imaging range. In another embodiment, the flight path processing unit 111 may be configured to calculate the vertical imaging interval based on the radius of the object, the vertical viewing angle of the aging device 220 or 230, and the vertical repetition rate of the imaging range.

In one embodiment, the flight path processing unit 111 may be configured to determine the imaging position (e.g., waypoint) at which the UAV 100 captures the object based on the flight range and the imaging position interval. The imaging positions of the UAV 100 may be arranged at equal intervals in the horizontal direction, and the distance between the last imaging position and the initial imaging position may be shorter than the imaging position interval. Further, this interval may be the horizontal imaging interval. The imaging positions of the UAV 100 may be arranged at equal intervals in the vertical direction, and the distance between the last imaging position and the initial imaging position may be shorter than the imaging position interval. Further, this interval may be the vertical imaging interval.

In one embodiment, the flight path processing unit 111 may be configured to generate a flight range (e.g. flight route) that passes the determined imaging position. The flight path processing unit 111 may sequentially pass through the respective imaging positions adjacent in the horizontal direction in a flight route, and after passing through all the imaging positions in the flight route, a flight path to the next flight route may be generated. Further, the flight path processing unit 111 may sequentially pass through the respective imaging positions adjacent in the horizontal direction on the next flight route, and after passing through all the imaging positions on the flight route, a flight path to the next flight route may be generated. In one embodiment, the starting point of the flight path may be from the air side and the height may gradually decrease as the UAV 100 travels along the flight path. In another embodiment, the starting point of the flight path may be from the ground side and the height may gradually increase as the UAV 100 travels along the flight path.

In one embodiment, the flight path processing unit 111 may control the flight of the UAV 100 based on the generated flight path. The flight path processing unit 111 may capture the object by using the imaging device 220 or 230 at the imaging positions included in the flight path. Further, the UAV 100 may be rotated around the side of the object and fly based on the flight path. As such, the imaging device 220 or 230 may capture the side of the object at the imaging positions in the flight path. The captured images acquired by the imaging device 220 or 230 may be stored in the memory 160. The UAV controller 110 may refer to the memory 160 as needed (e.g., when generating three-dimensional shape data).

The shape data processing unit 112 may be configured to generate stereoscopic information (e.g., three-dimensional information and three-dimensional shape data) indicating the stereoscopic shape (e.g., three-dimensional shape) of the object based on the plurality of captured images acquired at different imaging positions by any of the imaging devices 220 and 230. As such, the captured image may be used as an image for restoring the three-dimensional shape data. The captured image for restoring the three-dimensional shape data may be a still image. The three-dimensional shape data may be generated based on a plurality of captured images by using a well-known method. Some of the well-known methods may include the Multi View Stereo (MVS), Patch-based MVS (PMVS), and Structure from Motion (SfM).

The captured image used in the generation of the three-dimensional shape data may be a still image. The plurality of captured images used in the generation of the three-dimensional shape data may include two captured images in which the imaging ranges are partially overlapped with each other. The higher the ratio of the repetition (i.e., the repetition rate of the imaging range), the more the number of captured images may be used to generate the three-dimensional shape data when the three-dimensional shape data is generated in the same range. As such, the shape data processing unit 112 may improve the restoration accuracy of the three-dimensional shape. On the other hand, the lower the repetition rate of the imaging range, the less the number of captured images may be used to generate the three-dimensional shape data when the three-dimensional shape data is generated in the same range. As such, the shape data processing unit 112 may shorten the generation time of the three-dimensional shape data. In one embodiment, in the plurality of captured images, two captured images in which the imaging ranges are partially overlapped may not be included.

The shape data processing unit 112 may be configured to acquire a captured image including a side surface of the object as the plurality of captured images. As such, the shape data processing unit 112 may acquire image feature of a plurality of side surfaces of the object as compared with acquiring the captured images by uniformly photographing in the vertical direction from above, thereby improving the restoration accuracy of the three-dimensional shape around the object.

As shown in FIG. 4, the communication interface 150 may be in communication with the transmitter 50. The communication interface 150 may receive various instructions from the remote transmitter 50 for the UAV controller 110.

The memory may store the programs and the like needed for the UAV controller 110 to control the gimbal 200, the rotor mechanism 210, the imaging device 220, the imaging device 230, the GPS receiver 240, the IMU 250, the magnetic compass 260, and the barometric altimeter 270. The memory may be a computer readable recording medium, which may include at least one of a Static Random Access Memory (SRAM), a Dynamic Random Access Memory (DRAM), an Erasable Programmable Read Only Memory (EPROM), an Electrically Erasable Programmable Read-Only Memory (EEPROM), and a flash memory such as a USB memory. The memory 160 may be disposed include the UAV body 102, and it may be configured to be detachable from the UAV body 102.

The battery 170 may be used as a drive source for each part of the UAV 100 and supply the required power to each part of the UAV 100.

The gimbal 200 may rotatably support the imaging device 220 centered on one or more axes. For example, the gimbal 200 may rotatably support the imaging device 220 centered on the yaw axis, the pitch axis, and the roll axis. In some embodiments, the gimbal 200 may change the photographing direction of the imaging device 220 by rotating the imaging device 220 around one or more of the yaw axis, the pitch axis, and the roll axis.

The rotor mechanism 210 may include a plurality of rotors and a plurality of driving motors for rotating the plurality of rotors.

The imaging device 220 may be used to capture an image of an object in the desired imaging range and generates data of the captured image. The image data obtained through the imaging of the imaging device 220 may be stored in a memory of the imaging device or in the memory 160.

The imaging device 230 may be used to capture the surroundings of the UAV 100 and generate data of the captured image. The image data of the imaging device 230 may be stored in the memory 160.

The GPS receiver 240 may be configured to receive a plurality of signals transmitted from a plurality of navigation satellites (e.g., GPS satellites) indicating time and position (e.g., coordinates) of each GPS satellite. Further, the GPS receiver 240 may be configured to calculate the position (e.g., the position of the UAV 100) of the GPS receiver 240 based on plurality of received signals. Furthermore, the GPS receiver 240 may be configured to output the position information of the UAV 100 to the UAV controller 110. In some embodiments, the calculation of the position information of the GPS receiver 240 may be performed by the UAV controller 110 instead of the GPS receiver 240. As such, the UAV controller 110 may input the information indicating the time and the position of each GPS satellite included in the plurality of signals received by the GPS receiver 240.

The IMU 250 may be configured to detect the attitude of the UAV 100 and output the detection result to the UAV controller 110. In some embodiments, the IMU 250 may be configured to detect the front, rear, left, right, upward, and downward accelerations of the three-axis of the UAV 100 and the angular velocities in the three-axis directions of the pitch axis, the roll axis, and the yaw axis as the attitude of the UAC 100.

The magnetic compass 260 may be configured to detect the orientation of the nose of the UAV 100 and output the detection result to the UAV controller 110.

The barometric altimeter 270 may be configured to detect the flying height of the UAV 100 and output the detection result the UAV controller 110.

The ultrasonic altimeter 280 may be configured to emit ultrasonic waves, detect the ultrasonic waves reflected from the ground and the objects, and output the detection result to the UAV controller 110. The detection result may indicate the distance from the UAV 100 to the ground, that is, the altitude. In some embodiments, the detection result may indicate the distance from the UAV 100 to the object.

During the flight of the UAV 100 within the flight range (e.g., flight route) set for each flight height, the laser range finder 290, which is an example of an illuminometer, may be configured to irradiate a laser light onto the object and measure the distance between the UAV 100 and the object. In one embodiment, the measuring result may be input to the UAV controller 110. In addition, the illuminometer may not be limited to the laser ranger finder 290, and may be, for example, an infrared ranger finder that irradiates infrared rays.

An example configuration of the transmitter 50 will be described below.

FIG. 5 is a diagram illustrating an example of the appearance of a transmitter. The directions of the arrows shown in FIG. 5 are respectively observed with respect to the up, down, left, right, front, and rear directions of the transmitter 50. In some embodiments, the transmitter 50 may be used in a state in which, for example, a user of the transmitter 50 may be holding it with both hands.

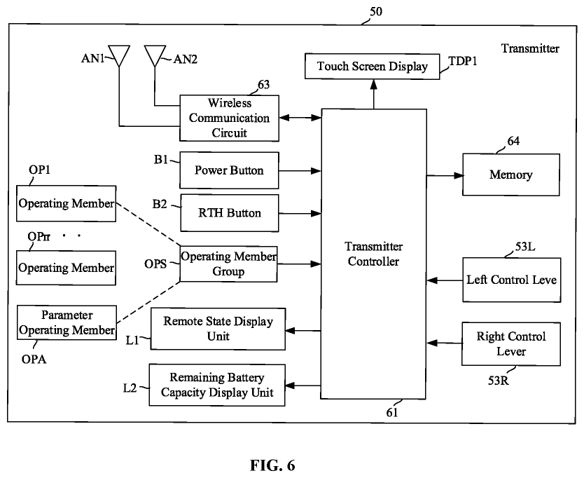

The transmitter 50 may include a resin housing 50B having, for example, an approximately square bottom surface and an approximately cuboid shape (in other words, an approximately box shape) having a height shorter than a side of the bottom surface. For the specific configuration of the transmitter 50, reference may be made to FIG. 6, which will be described below. Further, a left control lever 53L and a right control lever 53R are protruded from approximately the center of the housing surface of the transmitter 50.

The left control lever 53L and the right control lever 53R may be respectively used by the user to remotely control the movement operation (e.g., the forward, backward, right, left, up, and down movement and the orientation change of the UAV 100) of the UAV 100. The position of the initial state in which the left lever 53L or the right lever 53R is not applied with an external force from the use's hands is shown in FIG. 5. Each of the left lever 53L and the right lever 53R may automatically return to a predetermined position (e.g., the initial position shown in FIG. 5) after the external force applied by the user is released.

In one embodiment, a power button B1 of the transmitter 50 may be disposed on a front near side (i.e., the side of the user) of the left control lever 53L. When the user presses the power button B1 once, the remaining capacity of a built-in battery (not shown) for the transmitter 50 may be displayed on a remaining battery capacity display unit L2. When the user presses the power button B1 again, for example, the power of the transmitter 50 may be turned on, and the power may be applied to each part of the transmitter 50 (see FIG. 6) to be used.

In one embodiment, a Return-To-Home (RTH) button B2 may be disposed on the front near side (i.e., the side of the user) of the right control lever 53R. When the user presses the RTH button B2, the transmitter 50 may transmit a signal to the UAV 100 for automatically returning the UAV 100 to a predetermined position. As such, the transmitter 50 may cause the UAV 100 to automatically return to the predetermined position (e.g., the takeoff position stored in the UAV 100). For example, the RTH button B2 may be used in the case where the user cannot see the body of the UAV 100 when perform the aerial imaging outdoor using the UAV 100 or when the UAV 100 may not be operable due to radio wave interference or unpredicted failure.

A remote state display unit L1 and the remaining battery capacity display unit L2 may be disposed on the front near side (i.e., the side of the user) of the power button B1 and the RTH button B2. The remote state display unit L1 may include, for example, a Light Emitting Diode (LED) and display the wireless connection state between the transmitter 50 and the UAV 100. The remaining battery capacity display unit L2 may include, for example, a LED and display the remaining capacity of the battery (not shown) built in the transmitter 50.

An antenna AN1 and an antenna AN2 may be protruding from a rear side surface of the housing 50B of the transmitter 50 on the rear side of the left control lever 53L and the right control lever 53R. The antennas AN1 and AN2 may be used to transmit a signal (e.g., a signal for controlling the movement of the UAV 100) generated by a transmitter controller 61 to the UAV 100 based on the operations of the operators left control lever 53L and the right control lever 53R. The antennas AN1 and AN2 may cover, for example, a transmission of 2 km. In addition, in the case where the image captured by the imaging devices 220 and 235 of the UAV 100 wireless connected to the transmitter 50 or the various data acquired by the UAV 100 is transmitted from the UAV 100, the antennas AN1 and AN2 may be used to receive these images or various data.

A touch screen display TPD1 may be made of, for example, a Liquid Crystal Display (LCD) or an organic Electroluminescence (EL). The shape, size, and arrangement position of the touch screen display TPD1 may be arbitrary, and may not be limited to the example shown in FIG. 6.

FIG. 6 a block diagram illustrating an example hardware configuration of the transmitter included in the three-dimensional shape estimation system of FIG. 1. The transmitter 50 includes the left control lever 53L, the right control lever 53R, the transmitter controller 61, a wireless communication unit 63, a memory 64, the power button B1, the RTH button B2, an operating member group (OPS), the remote state display unit L1, the remaining battery capacity display unit L2, and the touch screen display TPD1. The transmitter 50 is an example of an operating device that may be used to remotely control the UAV 100.

The left control lever 53L may be used, for example, for the operation of remotely controlling the movement of the UAV 100 by the operator's left hand. Further, the right control lever 53R may be used, for example, for the operation of remotely controlling the movement of the UAV 100 by the operator's right hand. The movement of the UAV 100 may be, for example, any one of a movement in a forward direction, a movement in a backward direction, a movement in the right direction, a movement in the left direction, a movement in an upward direction, a movement in a downward direction, a movement in which the UAV 100 may be rotated in the left direction, a movement in which the UAV 100 may be rotated in the right direction, or a combination thereof, and it may be the same in the following descriptions.

When the power button B1 is pressed once, a signal indicating the one time press may be transmitted to the transmitter controller 61. The transmitter controller 61 may be configured to display the remaining capacity of the battery (not shown) built in the transmitter 50 on the remaining battery capacity display unit L2 based on the signal. As such, the user may easily check the remaining capacity of the battery built in the transmitter 50. In addition, when the power button B2 is pressed twice, a signal indicating the double-press may be transmitted to the transmitter controller 61. The transmitter controller 61 may instruct the battery (not shown) built in the transmitter 50 to supply power to each part in the transmitter 50 based on the signal. As such, the power of the transmitter 50 may be turned on, and the user may easily start the use of the transmitter 50.

When the RTH button B2 is pressed, a corresponding signal may be transmitted to the transmitter controller 61. The transmitter controller 61 may generate a signal for automatically returning the UAV 100 to the predetermined position (e.g., the takeoff position of the UAV 100) based on the signal, and transmit the signal to the UAV 100 through the wireless communication unit 63 and the antennas AN1 and AN2. As such, the user may automatically return the UAV 100 to the predetermined position by performing a simple operation of the transmitter 50.

The OPS can include a plurality of operating members (e.g., operating member OP1 . . . operating member OPn, where n may be an integer greater than 2). In one embodiment, the OPS can include operating members (e.g., various operating members for providing assistance of the remote control of the UAV 100 through the transmitter 50) other than the left control lever 53L, the right control lever 53R, the power button B1, and the RTH button B2 shown in FIG. 5. The various operating members mentioned above may refer to, for example, buttons for instructing the capturing of a still image by using the imaging device 220 of the UAV 100, buttons for instructing the start and end of the recording of a moving image by using the imaging device 220 of the UAV 100, a dial for adjust the inclination of the gimbal 200 (see FIG. 4) of the UAV1 100 in the oblique direction, a button for switching the flight mode of the UAV 100, and a dial for setting the imaging device 220 of the UAV 100.

In addition, the operating member group OPS may include a parameter operating member OPA for inputting input parameter information. The input parameters may be used to generate the imaging interval position, the imaging position, or the flight path of the UAV 100. The parameter operating member OPA may be formed by an operation lever, a button, a touch screen, etc. Further, parameter operating member OPA may also be formed by the left control lever 53L and the right control lever 53R. Furthermore, the timing at which the parameter operating member OPA inputs each parameter included in the input parameters may be the same or different.

The input parameters may include one or more of the flight range information, radius information of the flight range (e.g., radius of the flight path), center position information of the flight range, radius information of the object, height information of the object, horizontal repetition rate information, vertical repetition rate information, and resolution information of the imaging device 220 or 230. Further, the input parameters may include one or more of the initial height information of the flight path, ending height information of the flight path, and initial imaging position information of the flight path. Furthermore, the input parameters may include one or more of the horizontal imaging interval information and the vertical imaging interval information.

The parameter operating member OPA may be used to input one or more of the flight range information, radius information of the flight range (e.g., radius of the flight path), center position information of the flight range, radius information of the object, height information (e.g., the initial height and the ending height) of the object, horizontal repetition rate information, vertical repetition rate information, and resolution information of the imaging device 220 or 230 by inputting a specific value or a range of latitude/latitude. Further, the parameter operating member OPA may be used to input one or more of the initial height information of the flight path, ending height information of the flight path, and initial imaging position information of the flight path by inputting a specific value or a range of latitude/latitude. Furthermore, the parameter operating member OPA may be used to input one or more of the horizontal imaging interval information and the vertical imaging interval information by inputting a specific value or a range of latitude/latitude.

Since the remote state display unit L1 and the remaining battery capacity display unit L2 have been described with reference to FIG. 5, the description thereof will be omitted.

The transmitter controller 61 may include a processor (e.g., a CPU, a MPU, or a DSP). The transmitter controller 61 may be used to perform the signal processing for the overall control of the operation of each of part of the transmitter 50, input/output processing of data with other parts, arithmetic processing of data, and storage processing of data.

In one embodiment, the transmitter controller 61 may be configured to generate an instruction signal for controlling the movement of the UAV 100 through the operation of the user's left control lever 53L and the right control lever 53R. The transmitter controller 61 may be used to remotely control the UAV 100 by transmitting the generated signal to the UAV 100 through the wireless communication unit 63 and the antennas AN1 and AN2. As such, the transmitter 50 may remotely control the movement of the UAV 100. For example, as an example of a setting unit, the transmitter controller 61 may be used to set the flight range (e.g., the flight route) of each flight height of the UAV 100. In addition, as an example of a determination unit, the transmitter controller 61 may be used to determine whether or not the next flight height of the UAV 100 may be below a predetermined flight height (e.g., an ending height H_{end}). Further, as an example of a flight controller, the transmitter controller 61 may be used to control the flight of the UAV 100 within the flight range (e.g., flight route) of each flight height.

In one embodiment, the transmitter control 61 may be configured to acquire map information of a map databased stored in an external server or the like via the wireless communication unit 63. The transmitter controller 61 may be used to display the map information via a display unit DP. The transmitter controller 61 may be further used to select the flight range and acquire the flight range information and the radius (radius of the flight path) information of the flight range via the parameter operating member OPA and by using a touch operation of the map information or the like. Further, the transmitter controller 61 may be used to select the object, acquire the radius information of the object, and acquire the height information of the object via the parameter operating member OPA and by using a touch operation of the map information or the like. Furthermore, the transmitter controller 61 may be used to calculate and acquire the initial height information of the flight path and the ending height information of the flight path based on the height information of the object. As such, the initial height and the ending height may be calculated within a range in which the side end portion of the object may be photographed.

In one embodiment, the transmitter controller 61 may be used to transmit the input parameters input by the parameter operating member OPA to the UAV 100 via the wireless communication unit 63. The transmitting time of the parameters included in the input parameters may all be the same time or different times.

In one embodiment, the transmitter controller 61 may be configured to acquire the input parameter information obtained by the parameter operating member OPA and transmit the input parameter information to the display unit DP and the wireless communication unit 63.

The wireless communication unit 63 may be coupled to the two antennas AN1 and AN2. The wireless communication unit 63 may be configured to perform the transmission and reception of information and data by using a predetermined wireless communication method (e.g., Wi-Fi) with the UAV 100 through the two antennas AN1 and AN2. The wireless communication unit 63 may transmit the input parameter information from the transmitter controller 61 to the UAV 100.

The memory 64 may include, for example a Read-Only Memory (ROM) in which a program for designating the operation of the transmitter controller 61 and set value data may be stored, and a Random-Access Memory (RAM) that may temporarily store various types of data and information used when the transmitter controller 61 performs processing. The program and set value data stored in the ROM of the memory 64 may be copied to a predetermined recording medium (e.g., a CD-ROM or a DVD-ROM). In addition, the aerial image data captured by the imaging device 220 of the UAV 100 may be stored, for example, in the RAM of the memory 64.

The touch screen display TPD1 may be used to display various data processed by the transmitter controller 61. Further, the touch screen display TPD1 may be used to display the inputted input parameter information. As such, the user of the transmitter 50 may check the input parameter content by using the touch screen display TPD1.

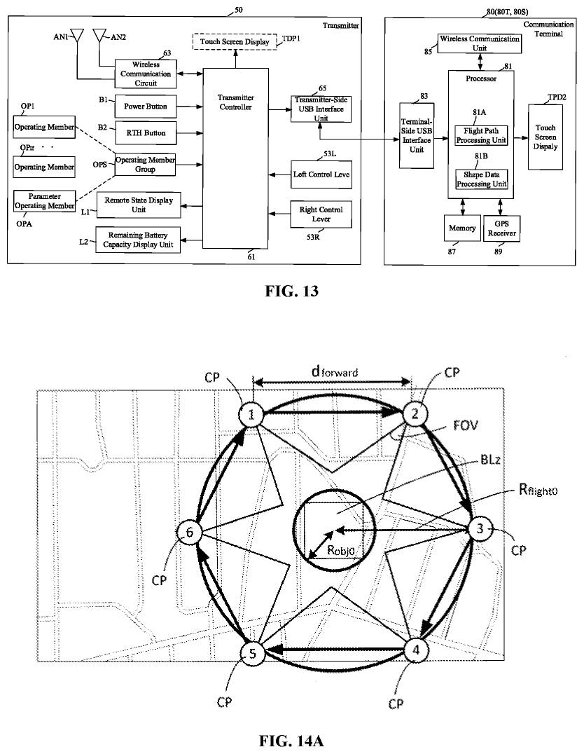

In addition, the transmitter 50 may be connected to a communication terminal 80 (see FIG. 13), which will be described below, by wire or wirelessly, without including the touch screen display TPD1. Similar to the touch screen display TPD1, the communication terminal 80 may also be used to display the input parameter information. The communication terminal 80 may be a smartphone, a tablet terminal, a Personal Computer (PC), or the like. In one embodiment, the communication terminal 80 may be used to input one or more input parameters, transmit the input parameters to the transmitter 50 by wired communication or wireless communication, and transmit the input parameters to the UAV 100 through the wireless communication unit 63 of the transmitter 50.

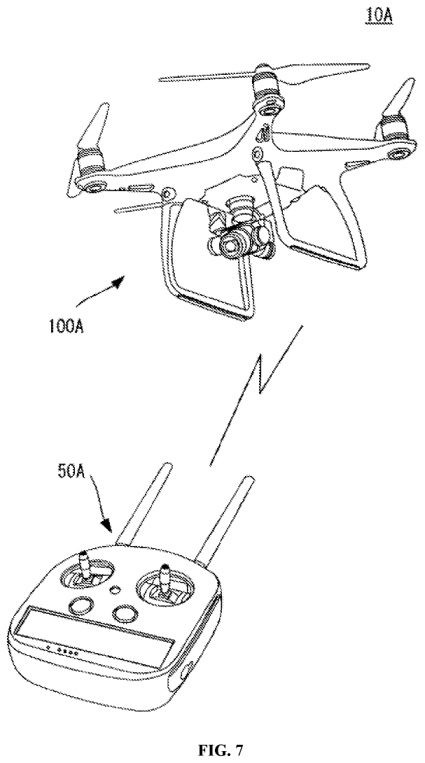

FIG. 7 is a diagram illustrating an example second configuration of the three-dimensional shape estimation system according to an embodiment of the present disclosure. As shown in FIG. 7, a three-dimensional shape estimation system 10A includes a least a UAV 100A and a transmitter 50A. The UAV 100A and the transmitter 50A may communicate by wired communication or wireless communication (e.g., wireless LAN or Bluetooth). In the second configuration example of the three-dimensional shape estimation system, the description may be omitted simplified for the same matter as in the first configuration example of the three-dimensional shape estimation system.

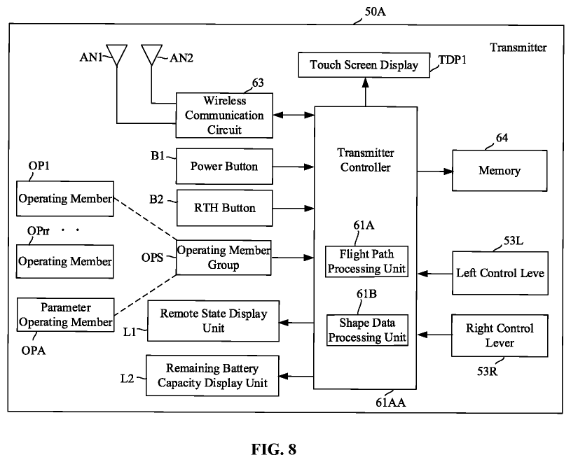

FIG. 8 is a block diagram illustrating an example hardware configuration of the transmitter included in the three-dimensional shape estimation system of FIG. 7. As compared with the transmitter 50, the transmitter 50A includes a transmitter controller 61AA instead of the transmitter controller 61. In the transmitter 50A of FIG. 8, the same configurations as those of the transmitter 50 of FIG. 6 are denoted by the same reference numerals, and the description thereof will be omitted or simplified.

In addition to the functions of the transmitter controller 61, the transmitter controller 61AA further includes a flight path processing unit 61A and a shape data processing unit 61B. The flight path processing unit 61A may be configured to perform processing related to the generation of the flight range (e.g., flight route) set for each flight height of the UAV 100. The shape data processing unit 61B may be configured to perform processing related to the estimation and generation of the three-dimensional shape data of the object. Further, the flight path processing unit 61A may be the same as the flight path processing unit 111 of the UAV controller 110 of the UAV 100 in the first configuration example of the three-dimensional shape estimation system. The shape data processing unit 61B may be the same as the shape data processing unit 112 of the UAV controller 110 of the UAV 100 in the first configuration example of the three-dimensional shape estimation system.

In one embodiment, the flight path processing unit 61A may be configured to acquire the input parameters inputted to the parameter operating member OPA. The flight path processing unit 61A may store the input parameters in the memory 64 as needed. Further, the flight path processing unit 61A may read at least a part of the input parameters from the memory 64 as need (e.g., when calculating the imaging position interval, when determining the imaging position, and when generating the flight range (e.g., flight route)).

The memory 64 may be used to store programs and the like needed for controlling the respective parts in the transmitter 50A. Further, the memory 64 may be used to store programs and the like needed for the flight path processing unit 61A and the shape data processing unit 61B to perform the processing. The memory may be a computer readable recording medium, which may include at least one of a Static Random Access Memory (SRAM), a Dynamic Random Access Memory (DRAM), an Erasable Programmable Read Only Memory (EPROM), an Electrically Erasable Programmable Read-Only Memory (EEPROM), and a flash memory such as a USB memory. The memory 160 may be disposed include the transmitter 50A, and it may be configured to be detachable from the transmitter 50A.

The flight path processing unit 61A may use the same method as the flight path processing unit 111 of the first configuration example of the three-dimensional shape estimation system to acquire (e.g., calculate) the imaging position interval, determine the imaging position, generate and set the flight range (e.g., flight route), and the like, and the detailed description is omitted here. From the output of the input parameters from the parameter operating member OPA to the acquisition (e.g., calculation) of the imaging position interval, the determination of the imaging position, and the generation and setting of the flight range (e.g., flight route), the transmitter 50A may process the tasks mentioned above using one device. Therefore, the communication may not occur in the determination of the imaging position and the generation and setting of the flight range (e.g., flight route). As such, the determination of the imaging position and the generation and setting of the flight range (e.g., flight route) may be realized without being affected by the communication environment. In addition, the flight path processing unit 61A may transmit the determined imaging position information and the generate flight range (e.g., flight route) information to the UAV 100A via the wireless communication unit 63.

The shape data processing unit 61B may receive and acquire the captured image acquired by the UAV 100A via the wireless communication unit 63. The received captured image may be stored in the memory 64. The shape data processing unit 61B may be configured to generate the stereoscopic information (e.g., the three-dimensional information and the three-dimensional shape data) indicating the stereoscopic shape (e.g., the three-dimensional shape) of the object based on the acquired plurality of captured images. The three-dimensional shape data may be generated based on a plurality of captured images by using a well-known method. Some of the well-known methods may include the Multi View Stereo (MVS), Patch-based MVS (PMVS), and Structure from Motion (SfM).

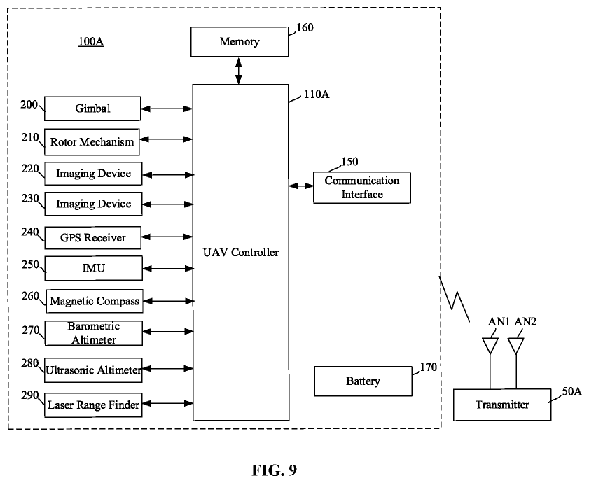

FIG. 9 is a block diagram illustrating an example hardware configuration of the UAV included in the three-dimensional shape estimation system of FIG. 7. As compared with the UAV 100, the UAV 100A includes a UAV controller 110A instead of the UAV controller 110. Further, the UAV controller 110A does not include the flight path processing unit 111 and the shape data processing unit 112 shown in FIG. 4. In the UAV 100A of FIG. 9, the same configuration as those of the UAV 100 of FIG. 4 are denoted by the same reference numerals, and the description thereof will be omitted or simplified.

The UAV controller 110A may be configured to receive and acquire each piece imaging position information and flight range (e.g., flight route) information from the transmitter 50A via the communication interface 150. The imaging position information and the flight range (e.g., flight route) information may be stored in the memory 160. The UAV controller 110A may control the flight of the UAV 100A based on the imaging position information and the flight range (e.g., flight route) information acquired from the transmitter 50A, and photograph the side surface of the object at each imaging position within the flight range (e.g., flight route). Each captured image may be stored in the memory 160. In addition, the UAV controller 110A may be configured to transmit the captured image acquired by the imaging device 220 or 230 to the transmitter 50A via the communication interface 150.

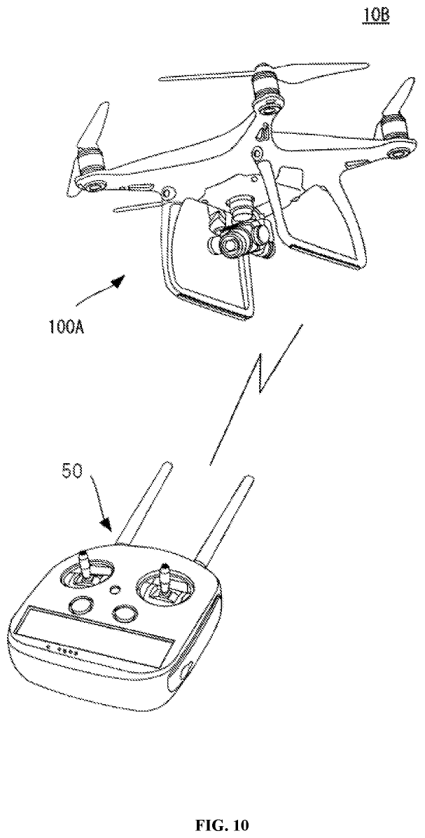

FIG. 10 is a diagram illustrating an example third configuration of the three-dimensional shape estimation system according to an embodiment of the present disclosure. As shown in FIG. 10, a three-dimensional shape estimation system 10B includes at least the UAV 100A (refer to FIG. 7) and the transmitter 50 A (refer to FIG. 1). The UAV 100A and the transmitter 50 can mutually communicate information and data by wired communication or wireless communication (e.g., a wireless LAN or Bluetooth). In addition, the illustration of the case where the communication terminal 80 may be mounted on the housing of the transmitter 50 is omitted in FIG. 10. In the third configuration example of the three-dimensional shape estimation system, the explanation is omitted or simplified for the same matters as in the first and second configuration examples of the three-dimensional shape estimation system.

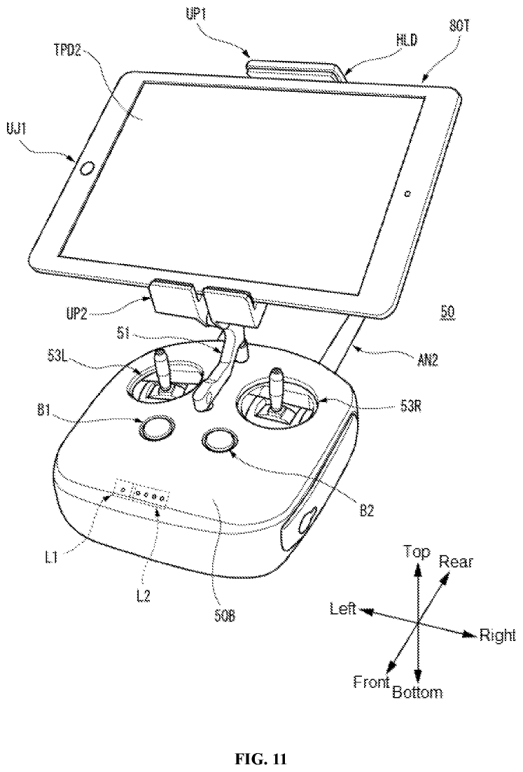

FIG. 11 is a perspective view illustrating an example of the appearance of the transmitter 50 in which a communication terminal (e.g., a tablet terminal 80T) is mounted, which is included in the three-dimensional shape estimation system 10B of FIG. 10. In the third configuration example, the directions of the arrows shown in FIG. 11 are respectively observed with respect to the up, down, left, right, front, and rear directions.

A bracket support portion 51 is configured using, for example, a metal processed into an approximately T shape including three joints. Two of the three joints (a first joint and a second joint) are engaged with the housing 50B, and one joint (a third joint) is engaged with a holder HLD. The first joint is inserted at an approximately central portion of the surface of the housing 50B of the transmitter 50 (e.g., a position surrounded by the left control lever 53L, the right control lever 53R, the power button B1, and the RTH button B2). The second joint is inserted into the rear side of the surface (e.g., a position on the rear side of the left control lever 53L and the right control lever 53R) of the housing 50B of the transmitter 50 via a screw (not shown). The third joint is disposed at a position away from the surface of the housing 50B of the transmitter 50 and is fixed to the holder HLD via a hinge (not shown). In one embodiment, the third joint may function as a fulcrum of the holder HLD, and the bracket support portion 51 may be used to support the holder HLD in a state of facing away from the surface of the housing 50B of the transmitter 50. In one embodiment, the angle of the holder HLD may be adjusted via the hinge through the user's operation.

The holder HLD includes a mounting surface of a communication terminal (e.g. the tablet terminal 80T in FIG. 11), an upper end wall portion UP1 that rises upward by approximately 90° on one end side of the mounting surface with respect to the mounting surface, and a lower end wall portion UP2 that rises upward by approximately 90° with respect to the mounting surface on the other end side of the mounting surface. The holder HLD may be used to hold the tablet terminal 80T and sandwich the tablet terminal 80T between the upper end wall portion UP1, the mounting surface, and the lower end wall portion UP2. The width of the mounting surface (in other words, the distance between the upper end wall portion UP1 and the lower end wall portion UP2) may be adjusted by the user. Further, the width of the mounting surface may be adjusted, for example, to be approximately the same as the width of one direction of the housing of the tablet terminal 80T to sandwich the tablet terminal 80T.

A USB connector UP into which one end of a USB cable (not shown) may be inserted is disposed in the tablet terminal 80T shown in FIG. 11. The tablet terminal 80T includes a touch screen display portion TPD2 as an example of a display portion. As such, the transmitter 50 may be connected to the touch screen display TPD2 of the tablet terminal 80T via the USB cable (not shown). Further, the transmitter 50 may include a USB port (not shown) on the back side of the housing 50B. The other end of the USB cable (not shown) may be inserted into the USB port (not shown) of the transmitter 50. As such, information and data may be input and output between the transmitter 50 and the communication terminal 80 (e.g., the tablet terminal 80T) via, for example, the USB cable (not shown). Furthermore, the transmitter 50 may include a micro USB port (not shown) and a micro USB cable (not shown) may be connected to the micro USB port (not shown).

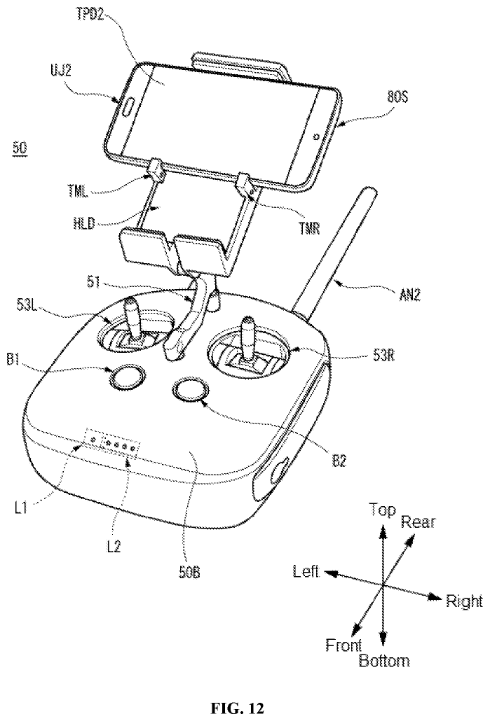

FIG. 12 is a perspective view illustrating an example of the appearance of the front side of the housing of the transmitter 50 in which the communication terminal (e.g., a smartphone 80S) is mounted, which is included in the three-dimensional shape estimation system 10B of FIG. 10. In the description of FIG. 12, the same reference numerals will be given to the same parts as those in the description of FIG. 11 to simplify or omit the description.

As shown in FIG. 12, the holder HLD includes a left claw TML and a right claw TMR at an approximately central portion between the upper end wall portion UP1 and the lower end wall portion UP2. For example, when the holder HLD is holding a relatively wider tablet terminal 80T, the left claw TML and the right claw TMR may be tilted along the mounting surface. On the other hand, for example, when the holder HLD is holding the smartphone 80S having a narrower width than the tablet terminal 80T, the left claw TML and the right claw TMR may rise upward by approximately 90° with respect to the mounting surface. As such, the smartphone 80S may be held by the upper end wall portion UP1, the law claw TML, and the right claw TMR of the holder HLD.

A USB connector UJ2 into which one end of a USB cable (not shown) may be inserted is disposed in the smartphone 80S shown in FIG. 12. The smartphone 80S includes the touch screen display portion TPD2 as an example of a display portion. Therefore, the transmitter 50 may be connected to the touch screen display TPD2 of the smartphone 80S via the USB cable (not shown). As such, information and data may be input and output between the transmitter 50 and the communication terminal 80 (e.g., the smartphone 80S) via, for example, the USB cable (not shown).

An antenna AN1 and an antenna AN2 may be protruding from a rear side surface of the housing 50B of the transmitter 50 on the rear side of the left control lever 53L and the right control lever 53R. The antennas AN1 and AN2 may be used to transmit a signal (e.g., a signal for controlling the movement and processing of the UAV 100) generated by a transmitter controller 61 to the UAV 100 based on the operations of the operators left control lever 53L and the right control lever 53R. The antennas AN1 and AN2 may cover, for example, a transmission of 2 km. In addition, in the case where the image captured by the imaging devices 220 and 235 of the UAV 100 wireless connected to the transmitter 50 or the various data acquired by the UAV 100 is transmitted from the UAV 100, the antennas AN1 and AN2 may be used to receive these images or various data.

FIG. 13 is a block diagram illustrating an example of an electrical connection relationship between the transmitter 50 and the communication terminal 80 included in the three-dimensional shape estimation system 10B of FIG. 10. As described with reference to FIG. 11 or FIG. 12, the transmitter 50 and the communication terminal 80 may be connected through a USB cable (not shown) such that data and information may be input and output.

The transmitter 50 includes the left control lever 53L, the right control lever 53R, the transmitter controller 61, the wireless communication unit 63, the memory 64, a transmitter-side USB interface unit 65, the power button B1, the RTH button B2, an operating member group (OPS), the remote state display unit L1, and the remaining battery capacity display unit L2. The transmitter 50 may further include the touch screen display TPD1 that may be configured to detect a user operation, such as a touch or a tap.

In one embodiment, the transmitter controller 61 may be configured to acquire aerial image data captured by the imaging device 220 of the UAV 100 via, for example, the wireless communication unit 63, store the aerial image data in the memory 64, and display the aerial image data on the touch screen display TPD1. As such, the aerial image captured by the imaging device 220 of the UAV 100 may be displayed on the touch screen display TPD1 of the transmitter 50.

In one embodiment, the transmitter controller 61 may be configured to output the aerial image data captured by the imaging device 220 of the UAV 100 to the communication terminal 80 via, for example, the transmitter-side USB interface unit 65. That is, the transmitter controller 61 may be configured to display the aerial image data on the touch screen display TPD2 of the communication terminal 80. As such, the aerial image captured by the imaging device 220 of the UAV 100 may be displayed on the touch screen display TPD2 of the communication terminal 80.

In one embodiment, the wireless communication unit 63 may be configured to receive the aerial image data capture by the imaging device 220 of the UAV 100 through, for example, a wireless communication with the UAV 100. The wireless communication unit 63 may output the aerial image data to the transmitter controller 61. In another embodiment, the wireless communication unit 63 may be configured to receive the position information of the UAV 100 calculated by the UAV 100 including the GPS receiver 240 (refer to FIG. 4). Further, the wireless communication unit 63 may output the position information of the UAV 100 to the transmitter controller 61.

The transmitter-side USB interface unit 65 may be configured to perform the input and output of data and information between the transmitter 50 and the communication terminal 80. Further, the transmitter-side USB interface unit 65 may include, for example, a USB port (not shown) disposed on the transmitter 50.

The communication terminal 80 includes a processor 81, a terminal-side USB interface unit 83, a wireless communication unit 85, a memory 87, a GPS receiver 87, and a touch screen display TPD2. The communication terminal may be, for example, the tablet terminal 80T (refer to FIG. 11) or the smartphone 80S (refer to FIG. 12).

The processor 81 may include, for example, a CPU, an MPU, or a DSP. The processor 81 may be used to perform the signal processing for the overall control of the operation of each part of the communication terminal 80, input/output processing of data with other parts, arithmetic processing of data, and storage processing of data.

In one embodiment, as an example of the setting unit, the processor 81 may be used to set the flight range (e.g., the flight route) of each flight height of the UAV 100. In addition, as an example of the determination unit, the processor 81 may be used to determine whether or not the next flight height of the UAV 100 may be below a predetermined flight height (e.g., an ending height He′d). Further, as an example of a flight controller, the processor 81 may be used to control the flight of the UAV 100 within the flight range (e.g., flight route) of each flight height.

In one embodiment, the processor 81 may be configured to read and execute the program and data stored in the memory 87 and perform the related operations of a flight path processing unit 81A and a shape data processing unit 81B. The flight path processing unit 81A may be configured to perform processing related to the generation of the flight range (e.g., flight route) set for each flight height of the UAV 100. The shape data processing unit 81B may be configured to perform processing related to the estimation and generation of the three-dimensional shape data of the object. Further, the flight path processing unit 81A may be the same as the flight path processing unit 111 of the UAV controller 110 of the UAV 100 in the first configuration example of the three-dimensional shape estimation system. The shape data processing unit 81B may be the same as the shape data processing unit 112 of the UAV controller 110 of the UAV 100 in the first configuration example of the three-dimensional shape estimation system.

In one embodiment, the flight path processing unit 81A may be configured to acquire the input parameters input to the touch screen display TPD2. The flight path processing unit 81A may store the input parameters in the memory 64 as needed. Further, the flight path processing unit 81A may read at least a part of the input parameters from the memory 87 as need (e.g., when calculating the imaging position interval, when determining the imaging position, and when generating the flight range (e.g., flight route)).

The flight path processing unit 81A may use the same method as the flight path processing unit 111 of the first configuration example of the three-dimensional shape estimation system to acquire (e.g., calculate) the imaging position interval, determine the imaging position, generate and set the flight range (e.g., flight route), and the like, and the detailed description is omitted here. From the output of the input parameters from the touch screen display TPD2 to the acquisition (e.g., calculation) of the imaging position interval, the determination of the imaging position, and the generation and setting of the flight range (e.g., flight route), the communication terminal 80 may process the tasks mentioned above using one device. Therefore, the communication may not occur in the determination of the imaging position and the generation and setting of the flight range (e.g., flight route). As such, the determination of the imaging position and the generation and setting of the flight range (e.g., flight route) may be realized without being affected by the communication environment. In addition, the flight path processing unit 81A may transmit the determined imaging position information and the generate flight range (e.g., flight route) information to the UAV 100A through the transmitter 50 via the wireless communication unit 63.

In one embodiment, as an example of the shape estimation unit, the shape data processing unit 61B may be configured to receive and acquire the captured image acquired by the UAV 100A via the transmitter 50. The received captured image may be stored in the memory 87. The shape data processing unit 81B may be configured to generate the stereoscopic information (e.g., the three-dimensional information and the three-dimensional shape data) indicating the stereoscopic shape (e.g., the three-dimensional shape) of the object based on the acquired plurality of captured images. The three-dimensional shape data may be generated based on a plurality of captured images by using a well-known method. Some of the well-known methods may include the Multi View Stereo (MVS), Patch-based MVS (PMVS), and Structure from Motion (SfM).

In one embodiment, the processor 81 may be used to store the capture image data acquired via the terminal-side USB interface unit 83 in the memory 87 and display the capture image data on the touch screen display TPD2. In other words, the process 81 may display the aerial image data captured by the UAV 100 on the touch screen display TPD2.

In one embodiment, the terminal-side USB interface unit 83 may be configured to perform the input and output of data and information between the communication terminal 80 and the transmitter 50. In some embodiment, the terminal-side USB interface unit 83 may include, for example, the USB connector UJ1 provided on the tablet terminal 80T or the USB connector UJ2 provided on the smartphone 80S.

In one embodiment, the wireless communication unit 85 may be connected to a wide area network (not shown) such as the Internet via an antenna (not shown) built in the communication terminal 80. The wireless communication unit 85 may be configured to transmit and receive data and information from another communication device (not shown) connected to the wide area network.

The memory 87 may include, for example a ROM in which a program for designating the operation (e.g., a process and/or step performed by the flight path display method of the present disclosure) of the communication terminal 80 and set value data may be stored, and a RAM that may temporarily store various types of data and information used when the processor 81 performs processing. The program and set value data stored in the ROM of the memory 87 may be copied to a predetermined recording medium (e.g., a CD-ROM or a DVD-ROM). In addition, the aerial image data captured by the imaging device 220 of the UAV 100 may be stored, for example, in the RAM of the memory 87.

The GPS receiver 89 may be used to receive a plurality of signals transmitted from a plurality of navigation satellites (i.e., GPS satellites) indicating time and position (e.g., coordinates) of each GPS satellite. The GPS receiver 89 may calculate the position of the GPS receiver 89 (i.e., the position of the communication terminal 80) based on the received plurality of signals. Although the communication terminal 80 and the transmitter 50 may be connected via a USB cable (not shown), it can be understood that the communication terminal 80 and the transmitter 50 may be at approximately the same position. As such, it may be understood that the position of the communication terminal 80 may be approximately the same as the position of the transmitter 50. Further, although the GPS receiver 89 may be provided in the communication terminal 80, it may also be provided in the transmitter 50. In one embodiment, the method of connecting the communication terminal 80 and the transmitter 50 may not be limited to the wired connection based on a USB cable CBL, and it may be a wireless connection based on a predetermined short-range wireless communication (e.g., Bluetooth or Bluetooth Low Energy). The GPS receiver 89 may output the position information of the communication terminal 80 to the processor 81. In one embodiment, the calculation of the position information of the GPS receiver 89 may be performed by the processor 81 instead of the GPS receiver 89. As such, the information indicating the time and position of each GSP satellite included in the plurality of signals received by the GPS received 89 may be input to the processor 81.

The touch screen display TPD2 may be made of, for example, a Liquid Crystal Display (LCD) or an organic Electroluminescence (EL). Further, the touch screen display TPD2 may be used to display various types of data and information output by the processor 81. In one embodiment, the touch screen display TPD2 may display, for example, aerial image data captured by the UAV 100. In another embodiment, the touch screen display TPD2 may be configured to detect a user's input operation, such as a touch or a tap.

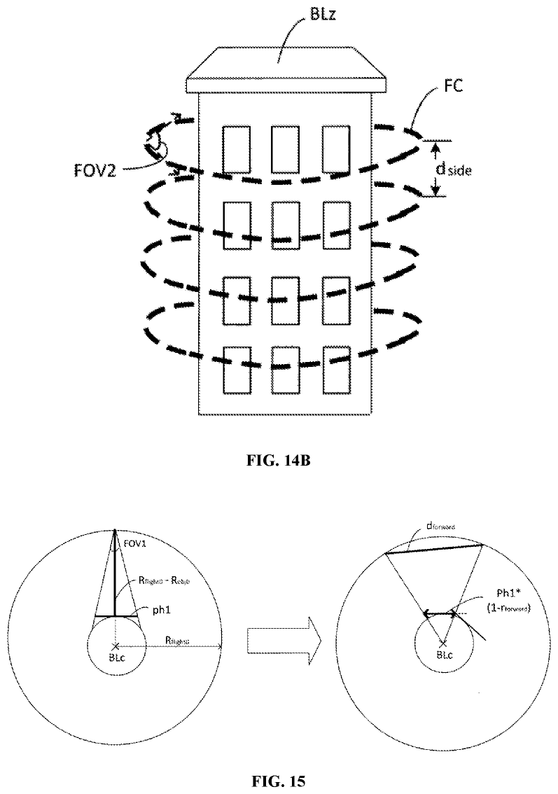

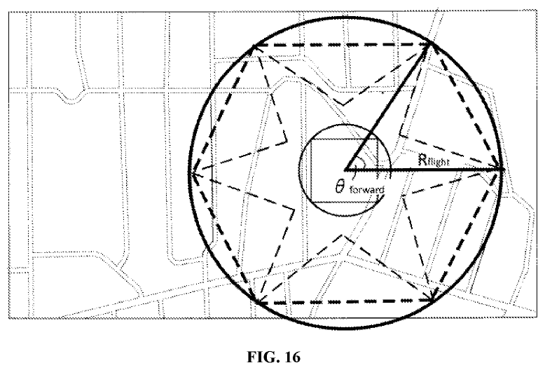

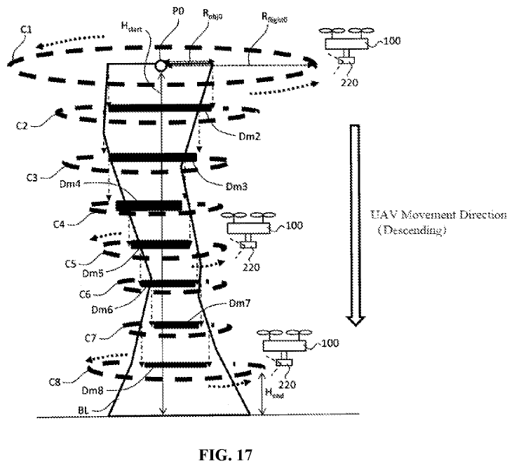

An example calculation method of the imaging position interval indicating the interval of the imaging position in the flight range (e.g., flight route) of the UAV 100 will be described below. In addition, in the description of FIG. 14A, FIG. 14B, FIG. 15, and FIG. 16, in order to facilitate the understanding of the description, the shape of the object BLz is described as a simple shape (e.g., a cylindrical shape). However, the description of FIG. 14A, FIG. 14B, FIG. 15, and FIG. 16 may be applicable when the shape of the object BLz is a complex shape (e.g., a shape in which the shape of the object may change depending on the flight height of the UAV).

FIG. 14A is a plan view of the periphery of the object viewed from above. FIG. 14B is a front view of the object viewed from the front. The front surface of the object BLz is an example of a side view of the object BLz viewed from the side (e.g., horizontal direction). In FIG. 14 A and FIG. 14B, the object BLz may be a building.

In one embodiment, the flight path processing unit 111 may be configured to calculate the horizontal imaging interval d_{forwrad} indicating the imaging position interval in the horizontal direction of the flight range (e.g., flight route) set for each flight height of the UAV 100 using mathematical formula (1).

$${d}_{forward} = ( {R}_{flight 0} - {R}_{obj 0} ) \times FOV 1 \times ( 1 - {r}_{forward} ) \times \frac{{R}_{flight 0}}{{R}_{obj 0}} \qquad ( 1 )$$

The definition of each parameter in the mathematical formula (1) is as follow.

R_{flight0}: the initial flight radius of the UAB 100 on the initial flight path C1 (refer to FIG. 17).

R_{obj0}: the radius (i.e., the approximately circular radius indicating the object BLz) of the object BL corresponding to the flight height of the UAV 100 on the initial flight path C1 (refer to FIG. 17).

FOV (Field of View) 1: the horizontal viewing angle of the imaging device 220 or the imaging device 230.

r_{forward}: the horizontal repetition rate.

In one embodiment, the flight path processing unit 111 may be configured to receive information (e.g., latitude and longitude information) of a center position BLc (refer to FIG. 15) of the object BLz included in the input parameters from the transmitter 50 via the communication interface 150.

The flight path processing unit 111 may be configured to calculate the initial flight radius R_{flight0} based on the set resolution of the imaging device 220 or the imaging device 230. As such, the flight path processing unit 111 may receive the set resolution information included in the input parameters from the transmitter via the communication interface 150. Further, the flight path processing unit 111 may receive the initial flight radius R_{flight0} information included in the input parameters. In one embodiment, the flight path processing unit 111 may receive the radius R_{obj0} information of the object BLz corresponding to the flight height of the UAV 100 on the initial flight path C1 (refer to FIG. 17) included in the input parameters from the transmitter 50 via the communication interface 150.

In one embodiment, the information of the horizontal field of view FOV1 may be stored in the memory 160 as related hardware information of the UAV 100 or acquired from the transmitter. When calculating the horizontal imaging interval, the flight path processing unit 111 may read the information of the horizontal field of view FOV1 from the memory 160. Further, the flight path processing unit 111 may receive the horizontal repetition rate r_{forward} from the transmitter 50 via the communication interface 150. In one embodiment, the horizontal repetition rate r_{forward} may be 90%.

The flight path processing unit 111 may be configured to calculate a plurality of imaging positions CP (e.g., waypoints) of each flight route FC on the flight path based on the acquired (e.g., calculated or received) imaging position interval. In some embodiments, the flight path processing unit 111 may arrange the imaging positions CP at equal intervals in the horizontal imaging interval on each flight route FC. In some embodiments, the flight path processing unit 111 may arrange the imaging positions CP at equal intervals between the upper and lower flight paths FC adjacent in the vertical direction.

When the imaging positions CP are placed in the horizontal direction, the flight path processing unit 111 may determine the initial imaging position CP (e.g., the first imaging position CP) on an arbitrary flight path FC as a reference point and arrange the imaging positions CP. The imaging positions CP may be sequentially arranged at equal intervals on the flight path FC based on the horizontal imaging interval by using the initial imaging position CP as a reference point. In one embodiment, after the flight path processing unit 111 arranges the imaging positions CP based on the horizontal imaging interval, the imaging position CP after circling around the flight path FC may not be arranged at the same position as the initial imaging position CP. In other words, the division of the circle around the flight path (i.e., 360°) at equal intervals may not use the imaging position CP. As such, there may be intervals on the same flight path FC where the horizontal imaging intervals are not equally placed. In addition, the distance between the imaging positions CP and the initial position CP may be the same as or shorter than the horizontal imaging interval.

FIG. 15 is an explanatory diagram for calculating of the horizontal imaging interval d_{forward}.

An approximation of the horizontal field of view FOV1 may be obtained by using mathematical formula (2) based on a horizontal direction component ph1 of the imaging range of the imaging device or the imaging device 230 and a distance from the object BLz as an imaging distance.

$$FOV 1 = \frac{ph 1}{{R}_{flight} - {R}_{obj 0}} \qquad ( 2 )$$

As such, the flight path processing unit 111 may calculate a part of the mathematical formula (1), that is, (R_{flight0}˜R_{obj0})*FOV1=ph1. As it can be seen from the above equation, the field of view (e.g., FOV1) may be represented by the ratio of the length (e.g., distance).

In one embodiment, when the flight path processing unit 111 acquires a plurality of captured images by the imaging device 220 or the imaging device 230, a part of the imaging ranges of the two adjacent captured images may be repeated. As such, the flight path processing unit 111 may generate the three-dimensional shape data by repeating a part of the plurality of imaging ranges.

In one embodiment, the flight path processing unit 111 may calculate a non-overlapping portion of the horizontal direction component ph1 of the imaging range that may not overlap the horizontal direction component of the adjacent imaging range as a part of the mathematical formula (1), that is, ph1*(1˜r_{forward}). The flight path processing unit 111 may expand the non-overlapping portion of the horizontal direction component ph1 of the imaging range to reach the circumferential end (e.g., flight path) of the flight range based on a ratio of the initial flight radius R_{flight0} to the radius R_{obj0} of the object BLz on the initial flight path C1, and use it as the horizontal imaging interval d_{forward} to perform imaging.

In one embodiment, the flight path processing unit 111 may be configured to calculate a horizontal angle θ_{forward} instead of the horizontal imaging interval d_{forward}. FIG. 16 is a view illustrating an example of the horizontal angle θ_{forward}. The horizontal angle may be calculate by using, for example, mathematical formula (3).

$${θ}_{forward} = \frac{{d}_{forward}}{{R}_{flight 0}} \qquad ( 3 )$$

In addition, the flight path processing unit 111 may be configured to calculate a vertical imaging interval d_{side} indicating the imaging position interval in the vertical direction by using mathematical formula (4).

d_{side}=(R_{flight0}−R_{obj0})×FOV2×(1−r_{side}) (4).

The definition of each parameter in the mathematical formula (4) is provided as follow. In addition, the description of the parameters used in the mathematical formula (1) will be omitted.

FOV2: the vertical viewing angle of the imaging device 220 or the imaging device 230.

r_{side}: the vertical repetition rate.

In one embodiment, the information of the vertical field of view FOV2 may be stored in the memory 160 as the related hardware information. When calculating the vertical imaging interval, the flight path processing unit 111 may read the information of the vertical field of view FOV2 from the memory 160. Further, the flight path processing unit 111 may receive the vertical repetition rate r_{side} in the input parameters from the transmitter 50 via the communication interface 150. In one embodiment, the vertical repetition rate r_{side} may be 60%.

By comparing the mathematical formula (1) with the mathematical formula (4), it can be seen that the calculation method of the vertical imaging interval d_{side} is essentially the same as the calculation method of the horizontal imaging interface d_{forward}, but the last term of the mathematical formula (1) (R_{flight0}/R_{obj0}) is not included in the mathematical formula (4). The reason being that, unlike the horizontal direction component ph1 of the imaging range, a vertical direction component ph2 (not shown) of the imaging range may directly correspond to the distance between the adjacent imaging position in the vertical direction.

In addition, the description provided above mainly describe the embodiment in which the flight path processing unit 111 is mainly used to calculate and obtain the imaging position interval. In some embodiments, the flight path processing unit 111 may receive the imaging position interval information from the transmitter 50 via the communication interface 150.

As described above, the imaging position interval may include horizontal imaging intervals, whereby the UAV 100 may arrange a plurality of imaging positions on the same flight path. As such, the UAV 100 may stably fly through a plurality of imaging positions without changing the flight height. Therefore, the UAV 100 may fly around the object BLz in the horizontal direction to stably capture images. Further, a plurality of captured images may be acquired for the same object BLz at different angles. As such, the restoration accuracy of the three-dimensional shape data on the entire side of the object BLz may be improved.

In one embodiment, the flight path processing unit 111 may be configured to determine the horizontal imaging interval based on at least the radius of the object BLz, the initial flight radius, the horizontal viewing angle of the imaging device 220 or 230, and the horizontal repetition rate. As such, the UAV 100 may appropriately acquire a plurality of captured images in the horizontal direction needed for the three-dimensional restoration in combination with various parameters such as the size and flight range of a specific object BLz. In addition, if the horizontal repetition rate or the like is increased and the imaging position interval is narrowed, the number of images of the captured image in the horizontal direction may be increased, and the UAV 100 may further improve the accuracy of the three-dimensional restoration.

Further, since the imaging position interval may include the vertical imaging intervals, the UAV 100 may acquire the captured image at different positions in the vertical direction, that is, at different heights. That is, the UAV 100 may acquire captured images at different heights that may be difficult to acquire when uniformly imaging from above. As such, a defective area when generating the three-dimensional shape data may be limited.

In one embodiment, the flight path processing unit 111 may be configured to determine the vertical imaging intervals based on at least the radius of the object BLz, the initial flight radius, the vertical viewing angle of the imaging device 220 or 230, and the vertical repetition rate. As such, the UAV 100 may appropriately acquire a plurality of captured images in the vertical direction needed for the three-dimensional restoration in combination with various parameters such as the size and flight range of a specific object BLz. In addition, if the vertical repetition rate or the like is increased and the imaging position interval is narrowed, the number of images of the captured image in the vertical direction may be increased, and the UAV 100 may further improve the accuracy of the three-dimensional restoration.

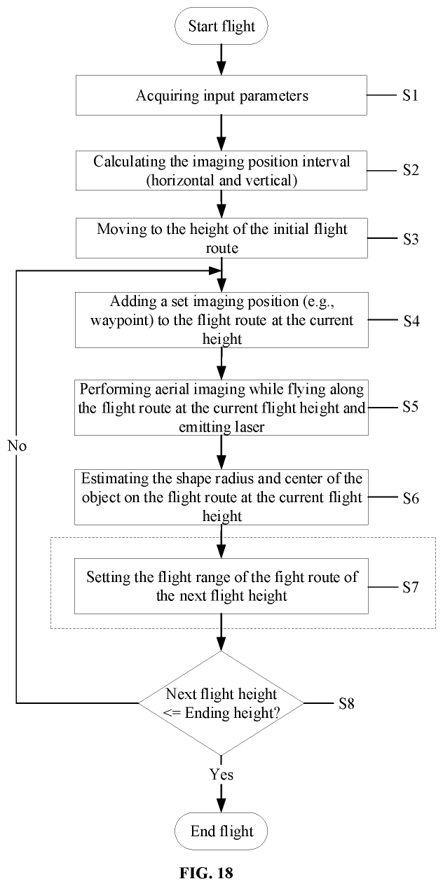

An embodiment of the operation of the three-dimensional shape estimation of the object BL will be described below with reference to FIG. 17 and FIG. 18.

FIG. 17 is an explanatory diagram illustrating an outline of an operation of estimating a three-dimensional shape of an object according to an embodiment of the present disclosure; and FIG. 18 is a flowchart illustrating an example of an operation procedure of a three-dimensional shape estimation method according to an embodiment of the present disclosure. An embodiment in which the three-dimensional shape of the object BL is estimated for the UAV 100 will be described below.

As shown in FIG. 17, for an irregularly shaped object BL, the shape radius and the center of the object BL corresponding to the flight range (e.g., flight route) of the flight range of the flight height may continuously change based on the flight range (e.g., flight route) of the flight height of the UAV 100.

As such, in one embodiment, as shown in FIG. 17, the UAV 100, for example, may first circulate around the vicinity of a top end (i.e., the height position of Hₛₜₐᵣₜ) of the object BL. The UAV 100 may perform the aerial imaging of the object BL of the corresponding flight height during the flight of the UAV 100. The imaging range of the imaging positions adjacent to each other among the plurality of imaging positions (refer to the imaging positions CP of FIG. 14A) may partially overlap. As such, the UAV 100 may calculate and set the flight range (e.g., flight route) of the next flight height based on a plurality of captured images obtained through the aerial imaging.

When the UAV 100 descends to the next set flight height (e.g., the flight height corresponding to a value obtained by subtracting the vertical imaging interval d_{side} from the height Hₛₜₐᵣₜ), the UAV 100 may also circulate within the flight range (e.g., flight route) of the flight height. In FIG. 17, the interval between the initial flight route C1 and a flight route C2 may correspond to a value by obtained by subtracting the vertical imaging interval d_{side} from the height Hₛₜₐᵣₜ. Similarly, the interval between the flight route C2 and a flight route C3 may correspond to a value by obtained by subtracting the vertical imaging interval d_{side} from the flight height of the flight route C2. Hereinafter, the interval between a flight route C7 and a flight route C8 may correspond to a value by obtained by subtracting the vertical imaging interval d_{side} from the flight height of the flight route C7.

The UAV 100 may perform the aerial imaging of the object BL of the corresponding flight height during the flight of the UAV 100. The imaging range of the imaging positions adjacent to each other among the plurality of imaging positions (refer to the imaging positions CP of FIG. 14A) may partially overlap. As such, the UAV 100 may calculate and set the flight range (e.g., flight route) of the next flight height based on a plurality of captured images as an example of object information obtained through the aerial imaging. In one embodiment, the method in which the UAV 100 calculates and sets the flight range (e.g., flight route) of the next flight height may not be limited to the method of using a plurality of captured images obtained through aerial imaging of the UAV 100. For example, the UAV 100 may calculate and set the flight range (e.g., flight route) of the next flight height by using, for example, infrared lights from an infrared range finder (not shown) or laser lights from the laser range finder 290 included in the UAV 100, or the position information of the GPS as the object information.

As described above, the UAV may set the flight range (e.g., flight route) of the next flight height based on a plurality of captured images acquired during the flight within the flight range (e.g., flight route) of the current flight height. The UAV 100 may repeated perform the aerial imaging of the object BL with the flight range (e.g., flight route) of each flight height and the setting of the flight range (e.g., flight route) of the next flight height until the current flight height drops below the predetermined ending height H_{end}.

In FIG. 17, in order to estimate the three-dimensional shape of the irregularly shaped object BL, the UAV 100 may set an initial flight range (e.g., the initial flight route C1) based on the input parameters and set, for example, a total of eight flight ranges (e.g., the initial flight route C1, and flight routes C2, C3, C4, C5, C6, C7, and C8). Subsequently, the UAV 100 may estimate the three-dimensional shape of the object BL based on the plurality of captured images of the object BL acquired on the flight path of each flight height.

In FIG. 18, the flight path processing unit 111 of the UAV controller 110 may be configured to acquire a plurality of input parameters (S1). The input parameters may all be, for example, stored in the memory 160 of the UAV 100, or the input parameters may be received by the UAV 100 via the communication from the transmitter 50 or the communion terminal 80.

In one embodiment, the input parameters may include the height of the initial flight path route C1 of the UAV 100 (e.g., the height Hₛₜₐᵣₜ indicating the height of the object BL), and the center position PO (e.g., the center position near the top of the object BL) information (e.g., latitude and longitude) of the initial flight route C1. Further, the input parameters may also include the initial flight radius R_{flight0} information on the initial flight route C1. As an example of the setting unit, the flight path processing unit 111 of the UAV controller 110 may set a circular range around the vicinity of the top end of the object BL determined by the input parameters as the initial flight route C1 of the UAV 100. As such, the UAV 100 may easily and reasonably set the initial flight route C1 for estimating the three-dimensional shape of the irregularly shaped object BL. In addition, the setting of the initial flight range (e.g., the initial flight route C1) may not be limited to the UAV 100 and the setting of the initial flight range may be set in the transmitter 50 or the communication terminal 80 as an example of the mobile platform.

In one embodiment, the input parameters may include the height of the initial flight path route C1 of the UAV 100 (e.g., the height Hₛₜₐᵣₜ indicating the height of the object BL), and the center position PO (e.g., the center position near the top of the object BL) information (e.g., latitude and longitude) of the initial flight route C1. Further, the input parameters may also include the initial flight radius R_{flight0} information on the initial flight route C1 and the set resolution information of the imaging devices 220 and 230. The flight path processing unit 111 of the UAV controller 110 may set a circular range around the vicinity of the top end of the object BL determined by the input parameters as the initial flight route C1 of the UAV 100. As such, the UAV 100 may easily and reasonably set the initial flight route C1 for estimating the three-dimensional shape of the irregularly shaped object BL based on the set resolution of the imaging devices 220 and 230. In addition, the setting of the initial flight range (e.g., the initial flight route C1) may not be limited to the UAV 100 and the setting of the initial flight range may be set in the transmitter 50 or the communication terminal 80 as an example of the mobile platform.

The flight path processing unit 111 of the UAV controller 110 may set the initial flight route C1 by using the input parameters acquired in S1, and further calculate the horizontal imaging interval d_{forward} (refer to FIG. 14A) in the horizontal direction and the vertical imaging interval d_{side} (refer to FIG. 14B) indicating the interval between the flight routes in the vertical direction of the initial flight route C1 based on the mathematical formula (1) and the mathematical formula (4) (S2).

After the calculation of S2, the UAV controller 110 may ascend and move the UAV 100 to the flight height position of the initial flight route C1 while controlling the gimbal 200 and the rotor mechanism 210 (S3). In addition, if the UAV 100 is already at the flight height position of the initial flight route C1, the processing of S3 may be omitted.

The flight path processing unit 111 of the UAV controller 110 may additionally set the imaging positions (e.g., waypoints) of the initial flight route C1 based on the calculation result of the horizontal imaging interval d_{forward} (refer to FIG. 14A) (S4).

The UAV controller 110 may control the gimbal 200 and the rotor mechanism 210 while controlling the UAV 100 to fly in a circle along the current flight route to surround the periphery of the object BL. During the flight, the UAV controller 110 may cause the imaging devices 220 and 230 to capture images (e.g., aerial imaging) of the object BL on the current flight path (e.g., any of the initial flight route C1 or other flight routes C2˜C8) at the imaging positions additional set in S4 (S5). More specifically, the UAV controller 110 may image the imaging ranges of the imaging devices 220 and 230 at each imaging position (e.g., waypoint) such that a part of the object BL may be repeated. As such, the UAV 100 may accurately estimate the shape of object BL on the flight path of the flight height based on the presence of the repeated object BL region among the plurality of captured images acquired on the adjacent imaging positions (e.g., waypoints). In addition, the object BL may be imaged based on an imaging instruction of the transmitter controller 61 or the processor 81 as an example of an acquisition instructing unit included in the transmitter 50 or the communication terminal 80 as an example of the mobile platform.

Further, the UAV controller 110 may control the laser range finder 290 to irradiate the laser lights toward the object BL on the current flight route (e.g., any of the initial flight route C1 or other flight routes C2˜C8)

The shape data processing unit 112 of the UAV controller 110 may estimate the shape (e.g., shapes Dm2, Dm3, Dm4, Dm5, Dm6, Dm7, and Dm8 shown in FIG. 17) of the object BL of the current flight height using a well-known method such as SfM based on the plurality of captured images of the object BL on the flight route of the current flight height acquired in S5 and a laser light receiving results from the laser range finder 290. The flight path processing unit 111 of the UAV controller 110 may estimate the shape radius and the center position of the object BL on the flight route of the current flight height based on the plurality of captured images and the distance measurement result of the laser range finder 290 (S6).

The flight path processing unit 111 of the UAV controller 110 may set the flight range (e.g., flight route) of the next flight height (e.g., the next flight route C2 of the initial flight route C1) by using the shape radius of the object BL on the flight route of the current flight height and the estimation result of the enter position (S7). As such, for an irregularly shaped object BL (e.g., a building) whose shape radius and center position may not be uniform due to the flight height, the UAV 100 may estimate the shape of the object BL in the order of the respective flight heights of the UAV 100, thereby estimating the three-dimensional shape of the entire object BL with high precision. In addition, the setting of the flight range (e.g., flight route) may not be limited to the UAV 100, and it may be set in the transmitter 50 or the communication terminal 80 as an example of the mobile platform.

For example, in S7, similar to the method of setting the initial flight route C1 by using the input parameters acquired in S1, the flight path processing unit 111 may set the next flight route by using the result of the estimation in S6 as the input parameter.

More specifically, in S7, the flight path processing unit 111 may consider the estimation result of the shape radius and center position of the object BL on the flight route of the current flight height as the same as the shape radius and center position of the object BL on the flight route of the next flight height, and set the flight range (e.g., flight route) of the next flight height. The flight radius of the flight range of the next flight height may be a value obtained by, for example the object radius estimated in S6 plus the imaging distance between the object BL and the UAV 100, or the imaging distance between the object BL and the UAV 100 corresponding to a set resolution suitable for imaging by the imaging devices 220 and 230.

After S7, the UAV controller 110 may acquire the current flight height based on, for example, the output of the barometric altimeter 270 or the ultrasonic altimeter 280. Further, the UAV controller 110 may determine whether or not the current flight height may be below the ending height H_{end}, which may be an example of the predetermined flight height (S8).

When it is determined that the current flight height is lower than the predetermined ending height H_{end} (S8, YES), the UAV controller 110 may end the flight around the object BL while gradually descending the flight height. Subsequently, the UAV controller 110 may estimate the three-dimensional shape of the object BL based on the plurality of captured imaged acquired by aerial imaging on the flight route of each flight height. As such, the UAV 100 may estimate the shape of the object BL by using the shape radius and center position of the object BL estimated on the flight route of each flight height, thereby estimating the three-dimensional shape of the subject BL having an irregular shape with high precision. In addition, the estimation of the three-dimensional shape of the object BL may not be limited to the UAV 100, and it may be estimated in the transmitter 50 or the communication terminal 80 as an example of the mobile platform.

On the other hand, when it is determined that the current flight height is not lower than the predetermined ending height H_{end} (S8, NO), the UAV controller 110 may control the gimbal 200 and the rotor mechanism 210 to descend the UAV 100 to the flight route of the next flight height. The next flight height may correspond to a value obtained by subtracting the vertical imaging interval d_{side} calculated in S2 from the current flight height. Subsequently, after descending, the UAV controller 110 may perform the processing of S4˜S8 on the flight route of the descended flight height. As such, the UAV 100 may estimate the three-dimensional shape of the object BL on the flight route of the plurality of flight heights, thereby estimating the three-dimensional shape of the entire object BL with high precision. In addition, the setting of the flight range (e.g., flight route) may not be limited to the UAV 100, and it may be set in the transmitter 50 or the communication terminal 80 as an example of the mobile platform.

In view of the foregoing description, the UAV 100 of the present disclosure may easily set the flight range by using the shape radius and the center position of the object BL on the flight route of the current flight height as the shape radius and the center position of the object on the flight route of the next flight height. As such, the flight and aerial imaging control for estimating the three-dimensional shape of the object BL may be implemented in advance. In addition, the setting of the flight range (e.g., flight route) may not be limited to the UAV 100, and it may be set in the transmitter 50 or the communication terminal 80 as an example of the mobile platform.

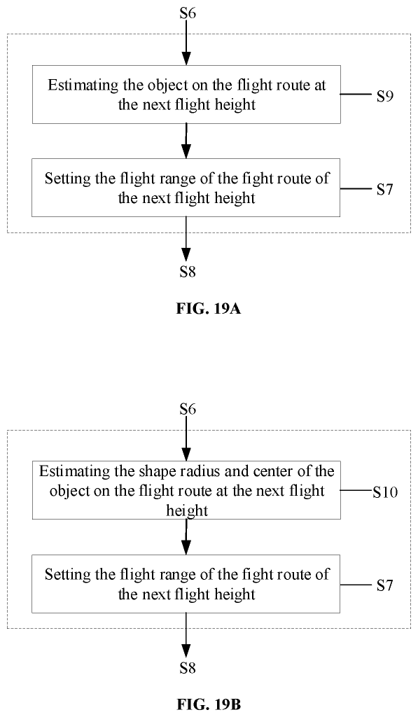

With respect to S7 of FIG. 18, as a first modification of S7, for example, may be replaced with S9 and S7 shown in FIG. 19A. Further, as a second modification of S7, for example, may be replaced with S10 and S7 shown in FIG. 19B.

FIG. 19A is a flowchart illustrating an example of the operation procedure of a modification of S7 of FIG. 18. That is, after S6 of FIG. 19, the shape data processing unit 112 of the UAV controller 110 may estimate the shape (e.g., shapes Dm2, Dm3, Dm4, Dm5, Dm6, Dm7, and Dm8 shown in FIG. 17) of the object BL of the next flight height using a well-known method such as SfM based on the plurality of captured images of the object BL on the flight route of the current flight height acquired in S5 and the laser light receiving results from the laser range finder 290 (S9). That is, S9 may be a process based on satisfying a condition that the shape of the object BL on the flight route of the next flight height may be mapped in the captured images on the flight route of the current flight height of the UAV 100. When the UAV controller 110 determines that this condition is satisfied, the processing of S9 described above may be performed.

In one embodiment, the flight path processing unit 111 of the UAV controller 110 may set the flight range (e.g., flight route) of the next flight height (e.g., the next flight route C2 of the initial flight route C1) of the current flight height during the flight of the UAV 100 by using the estimation result in S9. As such, the UAV 100 may estimate the shape of the object BL of the next flight height based on the plurality of captured images of the object BL on the flight route of the current flight height and the laser light receiving result from the laser range finder 290, thereby shortening the three-dimensional shape estimation process. In addition, the setting of the flight range (e.g., flight route) may not be limited to the UAV 100, and it may be set in the transmitter 50 or the communication terminal 80 as an example of the mobile platform.

FIG. 19B is a flowchart illustrating an example of the operation procedure of another modification of S7 of FIG. 18. That is, after S6 of FIG. 19, the shape data processing unit 112 of the UAV controller 110 may estimate the shape (e.g., shapes Dm2, Dm3, Dm4, Dm5, Dm6, Dm7, and Dm8 shown in FIG. 17) of the object BL of the next flight height using a well-known method such as SfM based on the plurality of captured images of the object BL on the flight route of the current flight height acquired in S5 and the laser light receiving results from the laser range finder 290 (S10). The shape estimation may estimate, for example, the shape of the object BL on the flight route of the current flight height by using differential processing or the like. That is, S9 may be a process based on satisfying a condition that the shape of the object BL on the flight route of the next flight height may not be mapped in the captured images on the flight route of the current flight height of the UAV 100, and the shape of the object BL of the current flight height and the shape of the object BL of the next flight height may be approximately the same. When the UAV controller 110 determines that this condition is satisfied, the processing of S10 described above may be performed.

In one embodiment, the flight path processing unit 111 of the UAV controller 110 may set the flight range (e.g., flight route) of the next flight height (e.g., the next flight route C2 of the initial flight route C1) of the current flight height during the flight of the UAV 100 by using the estimation result in S9. As such, the UAV 100 may estimate the shape of the object BL of the next flight height based on the plurality of captured images of the object BL on the flight route of the current flight height, the laser light receiving result from the laser range finder 290, and the estimation result of the shape of the object BL of the current flight height, thereby shortening the three-dimensional shape estimation process. In addition, the setting of the flight range (e.g., flight route) may not be limited to the UAV 100, and it may be set in the transmitter 50 or the communication terminal 80 as an example of the mobile platform.

As described above, in one embodiment, the UAV 100 may set a flight range for flying around the object BL of each flight height based on the height of the object BL. Further, the UAV 100 may control the flight within the set flight range of each flight height, and capture the object BL during the flight within the set flight range of each flight. The UAV 100 may estimate the three-dimensional shape of the object based on the plurality of captured images of the object BL acquired at each flight height. As such, the UAV 100 may estimate the shape of the object BL for each flight height. Therefore, regardless of whether or not the shape of the object BL changes with height, the shape of the object BL may be estimated with high precision to avoid collision of the UAV 100 with the object BL during flight.

In one embodiment, the UAV 100 may set the initial flight range (e.g., the initial flight route C1 of FIG. 17) to circulate the object based on the input parameters (refer to the following description). As such, an initial flight radius with certain degree of accuracy may be input. Therefore, the user may need to know the approximate radius of the object BL in advance, which may increase the user's burden.

As such, in one embodiment, the UAV 100 may adjust the initial flight route C1 even if the user does not know the approximate radius of the object BL in advance. Therefore, it may be possible to fly around the object BL at the related height at least twice based on the height Hₛₜₐᵣₜ acquired as a part of the input parameters.

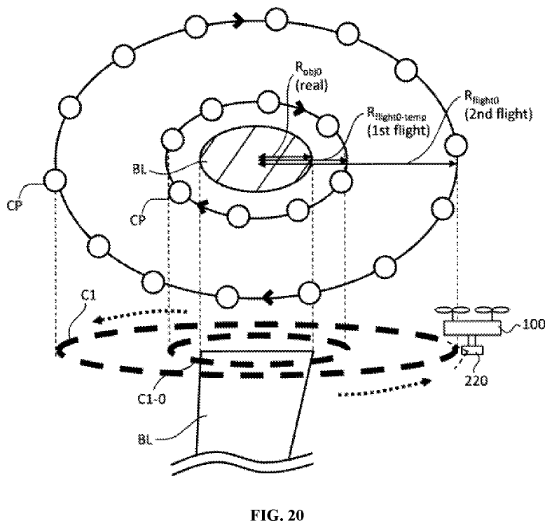

FIG. 20 is an explanatory diagram illustrating the outline of the operation of estimating the three-dimensional shape of the object according to another embodiment of the present disclosure. More specifically, the UAV 100 may set the initial flight route C1-0 at the time of the first flight by using the radius of the object BL R_{obj0} and the initial flight radius R_{flight0}-temp included in the input parameters. The UAV 100 may estimate the shape radius and the center position of the object BL on the initial flight route C1-0 based on the plurality of captured images of the object BL acquired during the flight of the set initial flight route C1-0 and the distance measurement result of the laser range finder 290. Further, the UAV 100 may use the estimated result to adjust the initial flight route C1-0.

The UAV 100 may fly along the adjusted initial flight route C1 during the second flight while imaging the object BL. Further, the UAV 100 may estimate the shape radius and the center position of the object BL on the adjusted initial flight route C1 based on the plurality of captured images and the distance measurement result of the laser ranger finder 290. For example, the UAV may accurately adjust the initial flight radius R_{flight0-temp} through the first flight. Further, the initial flight radius R_{flight0-temp} may be adjusted to the initial flight radius R_{flight0}, and the next flight route may be set by using the adjusted result.

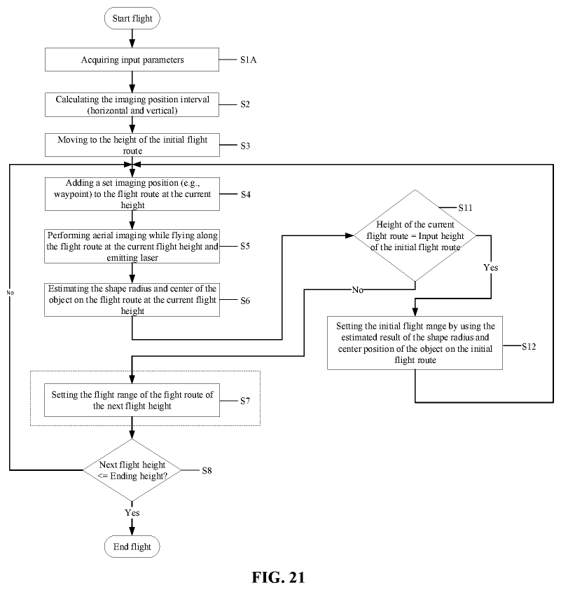

The operation procedure of the three-dimensional shape estimation of the object BL in another embodiment will be described with reference to FIG. 20 and FIG. 21. FIG. 21 is a flowchart illustrating an example of the operation procedure of the three-dimensional shape estimation method according to another embodiment of the present disclosure. An embodiment of the UAV 100 estimating the three-dimensional shape of the object BL will be described below. In addition, in the description of FIG. 21, the same parts as those in the description of FIG. 18 are denoted by the same reference numerals and the corresponding descriptions will be simplified or omitted, and different contents will be described.

In FIG. 21, the flight path processing unit 111 of the UAV controller 110 may be configured to acquire input parameters (S1A). Similar to the previous embodiment, the input parameters acquired in S1A may include the height of the initial flight path route C1-0 of the UAV 100 (e.g., the height Hₛₜₐᵣₜ indicating the height of the object BL), and the center position PO (e.g., the center position near the top of the object BL) information (e.g., latitude and longitude) of the initial flight route C1-0. In addition, the input parameters may also include the initial flight radius R_{flight0-temp} information on the initial flight route C1-0.

After S1A, the processing of S2˜S6 may be performed on the first initial flight route C1-0 of the UAV 100. After S6, the UAV controller 110 may determine whether the flight height of the current flight route and the height of the initial flight route C1-0 (e.g., the height Hₛₜₐᵣₜ indicating the height of the object BL) included in the input parameters acquired in S1A are the same (S11).

When the flight path processing unit 111 of the UAV controller 110 determines that the flight height of the current flight route is the same as the height of the initial flight route C1-0 included in the input parameters acquired in S1A (S11, YES), the estimation result of S6 may be used to adjust and set the initial flight range (e.g., the initial flight radius) (S12).

In one embodiment, after S12, the processing of the UAV may return to S4. In another embodiment, after S12, the processing of the UAV may return to S5. That is, the imaging positions (e.g., waypoints) in the flight of the second initial flight route may be the same as the imaging positions (e.g., waypoints) in the flight of the first flight route. As such, the UAV 100 may omit the setting processing of the imaging positions on the initial flight route C1 of the same flight height, thereby reducing the processing load.

On the other hand, when it is determined that the flight height of the current flight route is different from the height of the initial flight route C1-0 included in the input parameters acquired in S1A (S11, NO), the processing after S7 may be performed in the same manner as in the previous embodiment.

As described above, in the present embodiment, the UAV 100 may fly within the initial flight range (e.g., the initial flight route C1-0) set by the first flight object set based on the acquired input parameters. Further, the UAV 100 may estimate the radius and center position of the object BL on the initial flight route C1-0 based on the plurality of captured images of the object BL acquired during the flight of the initial flight route C1-0 and the distance measurement result of the laser range finder 290. The UAV 100 may adjust the initial flight range by using the estimated radius and center position of the object BL on the initial flight route C1-0. As such, for example, even if the user does not input the correct initial flight radius, the UAV 100 may easily determine the suitability of the initial flight radius through the flight of the first initial flight route C1-0. Therefore, it may be possible to acquire the correct initial flight radius and set the initial flight route C1 suitable for estimating the three-dimensional shape of the object BL. In addition, the flight and adjustment instruction of the initial flight range (e.g., the initial flight route C1-0) may not be limited to the UAV 100, and it may be set in the transmitter 50 or the communication terminal 80 as an example of the mobile platform.

In addition, the UAV 100 may fly along the initial flight route C1 adjust through the first flight and estimate the radius and the center position of the object BL on the initial flight range (e.g., the initial flight route C1) based on the plurality of captured images of the object BL acquired during the flight and the distance measurement result of the laser range finder 290. Further, the UAV 100 may set the flight range of the next flight height of the flight height of the initial flight range (e.g., the initial flight route C1) based on the estimation result. As such, the UAV 100 may adjust the initial flight route C1 even if the user does not know the approximate radius of the object BL in advance. In addition, the setting of the next flight route based on the flight of the initial flight range (e.g., the initial flight route C1-0) may not be limited to the UAV 100, and it may be set in the transmitter 50 or the communication terminal 80 as an example of the mobile platform.

The technical solution of the present disclosure have been described by using the various embodiments mentioned above. However, the technical scope of the present disclosure is not limited to the above-described embodiments. It should be obvious to one skilled in the art that various modifications and improvements may be made to the embodiments. It should also obvious from the scope of claims of the present disclosure that thus modified and improved embodiments are included in the technical scope of the present disclosure.

As long as the “before,” “previous,” etc. are not specifically stated, and as long as the output of the previous processing is not used in the subsequent processing, the execution order of the processes, sequences, steps, and stages in the devices, systems, programs, and methods illustrated in the claims, the description, and the drawings may be implement in any order. For convenience, the operation flows in the claims, description, and drawing have been described using terms such as “first,” “next,” etc., however, it does not mean these steps must be implemented in this order.

### DESCRIPTION OF THE REFERENCE NUMERALS

10 Three-dimensional shape estimation system
50 Transmitter
61 Transmitter controller
61A, 81A, 111 Flight path processing unit
61B, 81B, 112 Shape data processing unit
65, 85 Wireless communication unit
64, 87, 160 Memory
81 Processor
89, 240 GPS receiver
100 UAV
110 UAV controller
150 Communication interface
170 Battery
200 Gimbal
220, 230 Imaging device
250 Inertial measurement unit
260 Magnetic compass
270 Barometric altimeter
280 Ultrasonic altimeter
290 Laser range finder
TPD1, TPD2 Touch screen display
OP1, OPn Operating member

What is claimed is:

1. A three-dimensional shape estimation method comprising:
acquiring object information of a target object captured by an aerial vehicle while flying at a plurality of flight heights; and
estimating a three-dimensional shape of the target object based on the object information.

2. The method of claim 1, further comprising:
setting flight ranges of the aerial vehicle around the target object for respective ones of the plurality of flight heights based on a height of the target object.

3. The method of claim 2, wherein:
setting the flight ranges includes setting a flight range of a next flight height of the aerial vehicle based on the object information acquired by the aerial vehicle while flying at a current flight height.

4. The method of claim 3, wherein setting the flight range of the next flight height includes:
estimating a radius and a center of the target object at the current flight height based on the object information acquired by the aerial vehicle while flying within the flight range of the current flight height; and
setting the flight range of the next flight height according to the radius and the center of the target object at the current flight height.

5. The method of claim 3, wherein setting the flight range of the next flight height includes:
estimating a radius and a center of the target object at the next flight height based on the object information acquired by the aerial vehicle while flying within the flight range of the current flight height; and
setting the flight range of the next flight height according to the radius and the center of the target object at the next flight height.

6. The method of claim 3, wherein setting the flight range of the next flight height includes:
estimating a radius and a center of the target object at the current flight height based on the object information acquired by the aerial vehicle while flying within the flight range of the current flight height;
estimating a radius and a center of the target object at the next flight height according to the radius and the center of the target object at the current flight height; and
setting the flight range of the next flight height according to the radius and the center of the object at the next flight height.

7. The method of claim 2, further comprising:
controlling the aerial vehicle to fly within the flight ranges of the plurality of flight heights.

8. The method of claim 7, wherein:
setting the flight ranges includes estimating radii and centers of the target object at respective ones of the plurality of flight heights based on the object information acquired by the aerial vehicle while flying within the flight ranges of the respective ones of the plurality of flight heights; and
estimating the three-dimensional shape of the target object includes using the radii and the centers of the target object at the respective ones of the plurality of flight heights to estimate the three-dimensional shape of the target object.

9. The method of claim 7, wherein setting the flight ranges includes:
acquiring the height of the target object, a center of the target object, a radius of the target object, and a resolution of an imaging device of the aerial vehicle; and
setting an initial flight range of the aerial vehicle at one of the flight heights that is near a top end of the target object according to the height, the center, and the radius of the target object and the resolution of the imaging device.

10. The method of claim 7, wherein:
setting the flight ranges includes setting a plurality of imaging positions for the flight range of each of the flight heights; and
acquiring the object information includes repeatedly photographing a part of the target object by the aerial vehicle at a plurality of adjacent ones of the imaging positions among the plurality of set imaging positions.

11. The method of claim 7, further comprising:
determining whether a next flight height of the aerial vehicle is below a predetermined flight height; and
acquiring the object information includes repeatedly acquiring the object information within the flight ranges at the flight heights until it is determined that the next flight height is below the predetermined flight height.

12. The method of claim 7, wherein:
acquiring the object information includes photographing the target object by the aerial vehicle while flying within the flight ranges of respective ones of the flight heights; and
estimating the three-dimensional shape includes estimating the three-dimensional shape of the target object based on a plurality of captured images of the target object at the respective ones of the flight heights.

13. The method of claim 7, wherein acquiring the object information includes
acquiring a distance measured by an illuminator of the aerial vehicle and position information of the target object during flight of the aerial vehicle within the flight ranges of the flight heights.

14. The method of claim 7, wherein setting the flight ranges of the aerial vehicle includes:
acquiring the height of the object, a center of the object, and a flight radius of the aerial vehicle; and
setting an initial flight range of the aerial vehicle at one of the flight heights that is near a top end of the target object according to the height and the center of the target object and the flight radius of the aerial vehicle.

15. The method of claim 14, wherein setting the flight ranges includes:
controlling the aerial vehicle to fly within the initial flight range;
estimating a radius and a center of the target object within the initial flight range based on the object information acquired by the aerial vehicle while flying within the initial flight range; and
adjusting the initial flight range according to the radius and the center of the target object within the initial flight range.

16. The method of claim 15, wherein:
controlling the aerial vehicle to fly with the flight ranges includes controlling the aerial vehicle to fly within an adjusted initial flight range; and
setting the flight ranges includes:
estimating the radius and center of the object within the initial flight range based on a plurality of images of the object captured by the aerial vehicle while flying within the adjusted initial flight range; and
setting the flight range of a next flight height according to the radius and the center of the target object within the initial flight range.

17. An aerial vehicle comprising:
a memory storing a program; and
a processor coupled to the memory and configured to execute the program to:
acquire object information of a target object captured by the aerial vehicle while flying at a plurality of flight heights; and
estimate a three-dimensional shape of the target object based on the object information.

18. A computer-readable recording medium storing a computer program that, when executed by a processor of an aerial vehicle, causes the processor to:
acquire object information of a target object captured by the aerial vehicle while flying at a plurality of flight heights; and
estimate a three-dimensional shape of the target object based on the object information.
